(19) United States
(12) Patent Application Publication
(10) Pub. No.: US 2026/0271088 A1
(43) Pub. Date: Sep. 10, 2026

(54) RANDOM ACCESS CHANNEL ENHANCEMENTS FOR NETWORK ENERGY SAVING OPERATIONS

(71) Applicant: QUALCOMM Incorporated, San Diego, CA (US)

(72) Inventors: Tommy AZZINO, Jersey City, NJ (US); Navid ABEDINI, Basking Ridge, NJ (US); Cihat KECECI, Flemington, NJ (US); Tao LUO, San Diego, CA (US); Igor GUTMAN, Hod HaSharon (IL); Sony AKKARAKARAN, Poway, CA (US); Junyi LI, Greentown, PA (US)

(21) Appl. No.: 19/558,306

(22) Filed: Mar. 5, 2026

Related U.S. Application Data
(60) Provisional application No. 63/768,787, filed on Mar. 7, 2025.

(51) Int. Cl. H04W 74/0833

(52) U.S. Cl. CPC H04W 74/0833

(57) ABSTRACT

This disclosure provides methods, components, devices and systems for random access channel enhancements for network energy saving operations. For example, a user equipment (UE) may receive a signal that identifies a random access response (RAR) window configuration associated with a random access channel (RACH) procedure for the UE, wherein the RAR window configuration identifies a RAR window offset and an extended RAR window duration for a RAR window corresponding to a RACH occasion. The UE may transmit, during the RACH occasion, a first RACH message to initiate the RACH procedure for the UE. The UE may monitor, during the RAR window corresponding to the RACH occasion, for a second RACH message associated with the first RACH message according to the RAR window configuration.

### CROSS REFERENCE

The present Application for Patent claims the benefit of U.S. Provisional Patent Application No. 63/768,787 by AZZINO et al., entitled “RANDOM ACCESS CHANNEL ENHANCEMENTS FOR NETWORK ENERGY SAVING OPERATIONS,” filed Mar. 7, 2025, assigned to the assignee hereof, and expressly incorporated by reference herein.

### TECHNICAL FIELD

This disclosure relates generally to wireless communication, and more specifically to systems, devices, methods, and techniques associated with random access channel enhancements for network energy saving operations.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving a signal that identifies a random access response (RAR) window configuration associated with a RACH procedure for the UE, where the RAR window configuration identifies a RAR window offset and an extended RAR window duration for a RAR window corresponding to a RACH occasion, transmitting, during the RACH occasion, a first RACH message to initiate the RACH procedure for the UE, and monitoring, during the RAR window corresponding to the RACH occasion, for a second RACH message associated with the first RACH message according to the RAR window configuration.

A UE for wireless communications is described. The UE may include a processing system that includes processor circuitry and memory circuitry that stores code. The processing system may be configured to cause the UE to receive a signal that identifies a random access response (RAR) window configuration associated with a RACH procedure for the UE, where the RAR window configuration identifies a RAR window offset and an extended RAR window duration for a RAR window corresponding to a RACH occasion, transmit, during the RACH occasion, a first RACH message to initiate the RACH procedure for the UE, and monitor, during the RAR window corresponding to the RACH occasion, for a second RACH message associated with the first RACH message according to the RAR window configuration.

Another UE for wireless communications is described. The UE may include means for receiving a signal that identifies a random access response (RAR) window configuration associated with a RACH procedure for the UE, where the RAR window configuration identifies a RAR window offset and an extended RAR window duration for a RAR window corresponding to a RACH occasion, means for transmitting, during the RACH occasion, a first RACH message to initiate the RACH procedure for the UE, and means for monitoring, during the RAR window corresponding to the RACH occasion, for a second RACH message associated with the first RACH message according to the RAR window configuration.

A non-transitory computer-readable medium storing code for wireless communications is described. The code may include instructions executable (e.g., directly, indirectly, after pre-processing, without pre-processing) by one or more processors to receive a signal that identifies a random access response (RAR) window configuration associated with a RACH procedure for the UE, where the RAR window configuration identifies a RAR window offset and an extended RAR window duration for a RAR window corresponding to a RACH occasion, transmit, during the RACH occasion, a first RACH message to initiate the RACH procedure for the UE, and monitor, during the RAR window corresponding to the RACH occasion, for a second RACH message associated with the first RACH message according to the RAR window configuration.

In some examples of the method, user equipment (UEs), and non-transitory computer-readable medium described herein, the RAR window offset includes a starting symbol offset, a starting slot offset, a system frame number (SFN) offset, or any combination thereof, between an end of the RACH occasion and the RAR window.

In some examples of the method, user equipment (UEs), and non-transitory computer-readable medium described herein, the RAR window configuration may be based on a network energy saving (NES) operating mode of a network entity associated with the UE.

Some examples of the method, user equipment (UEs), and non-transitory computer-readable medium described herein may further include operations, features, means, or instructions for receiving an activation signal that activates the RAR window configuration to be used for the RACH procedure for the UE from among a set of multiple RAR window configurations that include the RAR window configuration.

Some examples of the method, user equipment (UEs), and non-transitory computer-readable medium described herein may further include operations, features, means, or instructions for receiving, after the RACH occasion and before the RAR window, a feedback notification that confirms receipt of the first RACH message, where the feedback notification may be different from the second RACH message.

Some examples of the method, user equipment (UEs), and non-transitory computer-readable medium described herein may further include operations, features, means, or instructions for receiving information that identifies a second RAR window for the UE to monitor for the feedback notification.

Some examples of the method, user equipment (UEs), and non-transitory computer-readable medium described herein may further include operations, features, means, or instructions for transmitting, during a first RAR window that may be before the RAR window, a second instance of the first RACH message on a second beam based on a beam change associated with the UE, where the first RACH message may be transmitted on a first beam that may be different from the second beam.

A method for wireless communications by a network entity is described. The method may include transmitting, to a UE, a signal that identifies a random access response (RAR) window configuration associated with a RACH procedure for the UE, where the RAR window configuration identifies a RAR window offset and an extended RAR window duration for a RAR window corresponding to a RACH occasion, receiving, from the UE and during the RACH occasion, a first RACH message to initiate the RACH procedure for the UE, and transmitting, to the UE during the RAR window corresponding to the RACH occasion, a second RACH message associated with the first RACH message according to the RAR window configuration.

A network entity for wireless communications is described. The network entity may include a processing system that includes processor circuitry and memory circuitry that stores code. The processing system may be configured to cause the network entity to transmit, to a UE, a signal that identifies a random access response (RAR) window configuration associated with a RACH procedure for the UE, where the RAR window configuration identifies a RAR window offset and an extended RAR window duration for a RAR window corresponding to a RACH occasion, receive, from the UE and during the RACH occasion, a first RACH message to initiate the RACH procedure for the UE, and transmit, to the UE during the RAR window corresponding to the RACH occasion, a second RACH message associated with the first RACH message according to the RAR window configuration.

Another network entity for wireless communications is described. The network entity may include means for transmitting, to a UE, a signal that identifies a random access response (RAR) window configuration associated with a RACH procedure for the UE, where the RAR window configuration identifies a RAR window offset and an extended RAR window duration for a RAR window corresponding to a RACH occasion, means for receiving, from the UE and during the RACH occasion, a first RACH message to initiate the RACH procedure for the UE, and means for transmitting, to the UE during the RAR window corresponding to the RACH occasion, a second RACH message associated with the first RACH message according to the RAR window configuration.

A non-transitory computer-readable medium storing code for wireless communications is described. The code may include instructions executable (e.g., directly, indirectly, after pre-processing, without pre-processing) by one or more processors to transmit, to a UE, a signal that identifies a random access response (RAR) window configuration associated with a RACH procedure for the UE, where the RAR window configuration identifies a RAR window offset and an extended RAR window duration for a RAR window corresponding to a RACH occasion, receive, from the UE and during the RACH occasion, a first RACH message to initiate the RACH procedure for the UE, and transmit, to the UE during the RAR window corresponding to the RACH occasion, a second RACH message associated with the first RACH message according to the RAR window configuration.

In some examples of the method, network entities, and non-transitory computer-readable medium described herein, the RAR window offset includes a starting symbol offset, a starting slot offset, a system frame number (SFN) offset, or any combination thereof, between an end of the RACH occasion and the RAR window.

In some examples of the method, network entities, and non-transitory computer-readable medium described herein, the RAR window configuration may be based on a network energy saving (NES) operating mode of the network entity associated with the UE.

Some examples of the method, network entities, and non-transitory computer-readable medium described herein may further include operations, features, means, or instructions for transmitting, to the UE, an activation signal that activates the RAR window configuration to be used for the RACH procedure for the UE from among a set of multiple RAR window configurations that include the RAR window configuration.

Some examples of the method, network entities, and non-transitory computer-readable medium described herein may further include operations, features, means, or instructions for transmitting, to the UE after the RACH occasion and before the RAR window, a feedback notification that confirms receipt of the first RACH message, where the feedback notification may be different from the second RACH message.

Some examples of the method, network entities, and non-transitory computer-readable medium described herein may further include operations, features, means, or instructions for transmitting, to the UE, information that identifies a second RAR window for the UE to monitor for the feedback notification.

Some examples of the method, network entities, and non-transitory computer-readable medium described herein may further include operations, features, means, or instructions for receiving, from the UE and during a first RAR window that may be before the RAR window, a second instance of the first RACH message on a second beam based on a beam change associated with the UE, where the first RACH message may be received on a first beam that may be different from the second beam.

### BRIEF DESCRIPTION OF THE DRAWINGS

FIG. 1 shows an example of a wireless communication system.

FIG. 2 shows an example of a signaling configuration that supports random access channel (RACH) enhancements for network energy saving (NES) operations.

FIGS. 3A and 3B show examples of a diagram that supports RACH enhancements for NES operations.

FIG. 4 shows an example of a signaling configuration that supports RACH enhancements for NES operations.

FIG. 5 shows a block diagram of a processing system that supports RACH enhancements for NES operations.

FIG. 6 shows a diagram of a system including a device that supports RACH enhancements for NES operations.

FIG. 7 shows a block diagram of a processing system that supports RACH enhancements for NES operations.

FIG. 8 shows a diagram of a system including a device that supports RACH enhancements for NES operations.

FIGS. 9 through 13 show flowcharts illustrating methods that support RACH enhancements for NES operations.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems may support network energy saving (NES) operations to reduce power consumption associated with the network. The NES operations may support a network entity to enter into a sleep or low-power mode by turning off some of its components, functions, or operations, during low or no load scenarios. The NES operations may include various degrees of the sleep mode for the network entities based on the traffic conditions or other considerations. However, a network entity transitioning from a low-power mode of operations (e.g., according to NES operations) to an active mode may be associated with a large latency. For example, the network entity may be equipped with a low-power radio that is operational during the sleep mode and a main radio that is operational during the active mode. Transitioning to the active mode by the network entity may require activation and settling time for the main radio. This may create an issue for some user equipment (UE) operating within the coverage area of the network entity, such as for a random access channel (RACH) procedure, which may also be referred to as a physical random access channel (PRACH) procedure. The RACH procedure may be used to establish a wireless connection between the UE and the network entity to support wireless communications. Disruptions or delays to the RACH procedure may introduce additional delays to the wireless communications, which may provide a negative user experience.

Aspects of the subject matter described in this disclosure relate to improved RACH operations. For example, the techniques described herein provide for various RACH enhancements that may be applied during NES operations of the wireless network. Generally, these enhancements may include configuring random access response (RAR) windows for a second RACH message of the RACH procedure that are extended and/or offset relative to a first RACH message. The first RACH message may be a message one (Msg1) message in a four-step RACH procedure or may be a message A (MsgA) message in a two-step RACH procedure. Similarly, the second RACH message may be a message two (Msg2) in the four-step RACH procedure or a message B (MsgB) in the two-step RACH procedure. The extended RAR windows may support time for the network entity to transition to the active mode and transmit the second RACH message after receiving the first RACH message while operating in the sleep mode.

Thus, in some aspects this may include the UE receiving or otherwise obtaining (and the network entity transmitting or otherwise outputting) a signal that identifies RAR window configuration(s) associated with a RACH procedure for the UE. The RAR window configuration(s) may carry or otherwise convey information that identifies a RAR window offset and an extended RAR window duration for a RAR window corresponding to a RACH occasion (RO). That is, each RAR window configuration may identify a RAR window for an associated RO that is delayed and/or has an extended duration (e.g., relative to RAR windows configured while the network entity is operating in the active mode). The UE may transmit or otherwise output (and the network entity may receive or otherwise obtain), during the RACH occasion, the first RACH message to initiate the RACH procedure for the UE. The UE may monitor for (and the network entity may transmit or otherwise output), during the RAR window corresponding to the RO, for the second RACH message associated with the first RACH message according to the RAR window configuration.

Particular aspects of the subject matter described in this disclosure can be implemented to realize one or more of the following potential advantages. In some examples, by extending or offsetting the RAR windows, the described techniques can be used to support RACH procedures for UE while the network entity is operating in the NES mode. In some examples, the network entity may support transmission of a feedback signal that acknowledges receipt of the first RACH message to avoid the UE unnecessarily retransmitting the first RACH message based on a RAR window timeout.

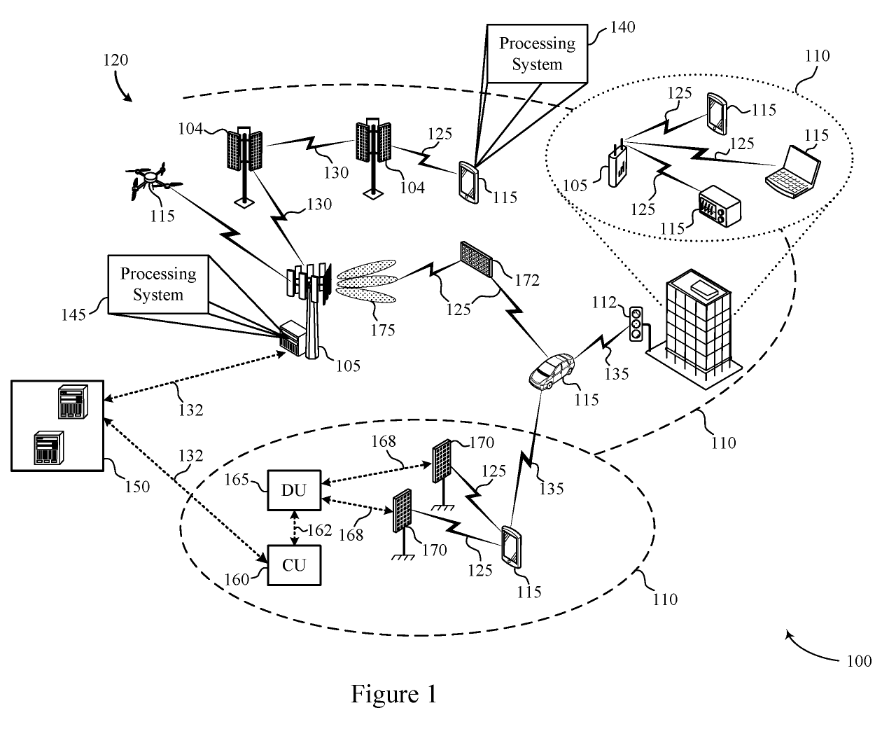

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105 and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration) or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for RACH enhancements for NES operations. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support NES operations for the network entity 105 while also enabling RACH operations for the UE 115. This may be associated with RAR window configurations that extend or offset the RAR window for the second RACH message to allow the network entity 105 to transition to an active state or mode (e.g., to activate its main radio).

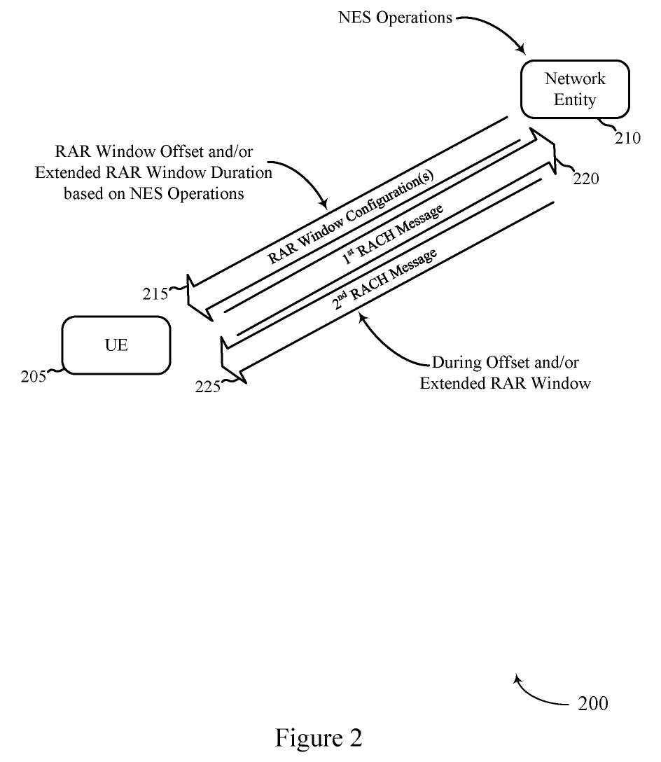

FIG. 2 shows an example of a signaling configuration 200 that supports RACH enhancements for NES operations. Aspects of the signaling configuration 200 may implement or be implemented by aspects of the wireless communications system 100. The signaling configuration 200 may include a UE 205 and a network entity 210, which may be examples of the corresponding devices described herein.

Aspects of the signaling configuration 200 may support NES features (e.g., at the network entity 210) to support green communications and reduce power consumption associated with the network. Some examples of such NES features may include, but are not limited to, RACH adaptation to support the NES feature as well as uplink wakeup signal (UL-WUS) to wakeup otherwise dormant cells performing NES operations. That is, the NES operations may allow the network entity 210 to sleep (e.g., turn off some of its components, such as the radio frequency (RF) frontend) for longer periods of time (e.g., for a deep sleep state or an ultra-deep sleep state) during low or no load scenarios. The (ultra) deep sleep state may enable greater energy savings for the network entity 210. However, when transitioning to or from the (ultra) deep sleep state, the network entity 210 may need a longer gap time to power off/on its components. For example, this gap time can be as high as 50 ms in some cases.

To enable longer periods of sleep time (e.g., the (ultra) deep sleep state), the network entity 210 may be equipped with a low-power radio and/or operate in a low-power-consuming state (e.g., by changing the configuration of its components, such as lowering the resolution of its analog-to-digital converters (ADCs)) and use such radio or operating mode for the common channels. For example, the synchronization signal blocks (SSBs) may be transmitted based on or via a canned or stored waveform (e.g., to avoid having the baseband processing active). In another example, the SSBs can be transmitted by a low-power wakeup transmitter (LP-WUT) of the network entity 210.

In another example, the RACH MSG1 monitoring by the network entity 210 can be performed using a low-power wakeup ratio (LP-WUR) or low-power mode of the network entity 210. This may result, in some cases, in it taking longer for network entity 210 to send a RAR (e.g., a RACH Msg2/MsgB) back to the UE. This may be the case since the network entity 210 may involve its main radio for processing of MSG1. The network entity 210 may store the received signal and may or may not perform any initial processing before further processing is conducted by main radio and/or other components.

Additionally, or alternatively, sending RAR may require turning on the main radio and/or other components of the network entity 210. However, this may take some additional time, in the form of gap time, as discussed above. The network entity 210 may desire to support a burst response to send the RAR for multiple RACH occasions (ROs) in a more compact (e.g., common) window. However, in some wireless networks the RAR window (monitored by the UE performing the RACH procedure) may start after the corresponding RO selected by the UE sending the RACH Msg1 (e.g., the first RACH message) and last for a fixed, configured duration. That is, such wireless networks may not provide a necessary means for flexible RAR window configuration.

That is, the legacy RAR window configuration cannot support NES operation enhancements by the network. According to such legacy RAR window configurations, the RAR window starts one symbol after the last symbol of the corresponding RO. Moreover, the duration of the legacy RAR window is fixed (e.g., is semi-statically configured in system information block one (SIB1) message) and may be less than or equal to 10 ms.

Accordingly, aspects of the described techniques may include the network entity 210 configuring a larger RAR window size (e.g., duration) and/or a RAR window offset from the end of the RO and the start of the RAR window. The described techniques support RAR window configuration enhancements to support the RACH procedure for the UE 205. The network entity 210 may semi-statistically configure one or multiple RAR window(s) with different configurations (e.g., starting at an absolute symbol, slot, system frame number (SFN), offsets and/or durations) with a corresponding mapping from ROs to RAR windows. This mapping may be one-to-one mapping, a many-to-one mapping, or a many-to-many mapping. This may support sending RAR for multiple ROs in one burst. Additionally, or alternatively, a different RAR duration can be configured for each RO.

For example, the RAR window may be configured with a starting offset from the last symbol of the associated RO to the actual start of the RAR window and/or configured with an increased length or duration (e.g., in number of slots). In some cases, different offsets may be configured or indicated to the UE 205 for different groups of one or multiple beams (e.g., SSBs) or ROs. Additionally, or alternatively, different RAR window durations may be configured or indicated to the UE 205 for different groups of one or multiple beams (SSBs) or ROs. This may support aligning the RAR window for multiple ROs, more compact burst of RAR(s), and/or different configurations, in case some beams or transmission reception points (TRPs) adopt the indicated NES feature (i.e., LP-WUR or LP-receive), and hence may need more time gap to respond with the second RACH message.

For example, at 215 the network entity 210 may transmit or otherwise output (and the UE 205 may receive or otherwise obtain) a signal that identifies one or more RAR window configurations associated with a RACH procedure for the UE. In some cases, the RAR window configuration(s) may be based on the network entity 210 being in or for when the network entity 210 is in a NES operating mode. For example, one, some, or all of the RAR window configuration(s) may carry or otherwise convey information that identifies a RAR window offset and/or an extended RAR window duration for a RAR window that corresponds to a RO. In some examples, the RAR window duration may be extended relative to the duration of the legacy RAR window. That is, the extended RAR window duration may be greater than 10 ms. The RAR window offset may include a starting symbol offset, a starting slot offset, and/or a system frame number (SFN) offset between an end of the RO and the RAR window (e.g., a start of the RAR window).

That is, the RAR window configuration(s) may enable the network entity 210 to operate in the NES operating mode while supporting RACH procedures for the UE 205. In some cases, the signal identifying the RAR window configuration(s) may include a SIB1, RRC signaling, or other signaling means.

At 220, the UE 205 may transmit or otherwise output (and the network entity 210 may receive or otherwise obtain) a first RACH message to initiate the RACH procedure for the UE 205. The first RACH message may be transmitted during a RO. As discussed, the RO may have one or more associated RAR windows during which the UE 205 is to monitor for a second RACH message. For example, the UE 205 may identify a RO during which to transmit the first RACH message and then identify the corresponding or associated RAR window according to the corresponding or associated RAR window configuration.

At 225, the network entity 210 may transmit or otherwise output (and the UE 205 may monitor for, receive, or otherwise obtain) a second RACH message associated with the first RACH message according to the RAR window configuration. For example, the second RACH message may be transmitted during the RAR window that corresponds to the RO during which the first RACH message was transmitted. As discussed above, the first RACH message may be a Msg1 in a four-step RACH procedure or a MsgA during a two-step RACH procedure. Similarly, the second RACH message may be a RAR, which may also be referred to as a Msg2 in the four-step RACH procedure or as a MsgB in the two-step RACH procedure.

In some cases, the network entity 210 may not always be configured with low-power radio or mode at certain times and/or for certain beams. In this case, signaling configuration 200 may support a more dynamic and efficient signaling technique to support the operating mode change. For example, the UE 205 may be configured with multiple RAR configurations (e.g., in terms of RAR window offset and/or duration mapping) and may be configured semi-statically by the network entity 210 where one RAR window configuration may be indicated to be active. For example, the network entity 210 may transmit or otherwise output (and the UE 205 may receive or otherwise obtain) an activation signal that activates the RAR window configuration to be used for the RACH procedure for the UE 205. In some cases, one RAR window configuration may be configured as a baseline or default configuration.

In some cases, the UE 205 may be configured with both a legacy RAR window configuration (e.g., a default or regular RAR window configuration) and an RAR window configuration for NES operations that identifies a RAR window offset and/or an extended RAR window duration relative to the legacy RAR window. That is, the legacy RAR window configuration may be configured as a default configuration (e.g., for normal or non-energy saving operations), and the RAR window configuration for NES operations may be configured or activated based on a NES state of the network entity 210.

Different techniques may be applied to carry or otherwise explicitly or implicitly indicate the active RAR window configuration to the UE 205. One technique may be that the active RAR window configuration is based or otherwise linked to NES state of the network entity 210. For example, when some other NES features such as discontinuous transmission/discontinuous reception (DTX/DRX) or on-demand (OD)-SSB or OD-SIB1 are configured, activated, or otherwise indicated, an associated RAR window configuration may also be adopted (e.g., be the active RAR window configuration). As another example, there may be an explicit indication of the operating state or mode of the network entity 210 (e.g., normal, NES1, NES2, etc.) and there may be a mapping from the operating state or mode to a RAR configuration. In some case, the UE 205 may send an inquire to the network entity 210 requesting its NES state or mode (e.g., using a low-power uplink wakeup signal (LP-UL-WUS).

Another technique to signal the active RAR window configuration may be that the configuration is associated with or otherwise linked to a RACH adaptation feature and piggybacked with the corresponding dynamic (de)activation (e.g., via a paging DCI). For example, when extra ROs are activated by the network entity 210 for the UE 205 the RAR window configuration may also be changed.

Another technique may be that the active RAR window configuration may be explicitly indicated to the UE 205 (e.g., via a broadcast or group-common message, or via a dedicated signal, such as a DCI, a paging early indication (PEI), a LP-WUS, a WUS, a short message, a MAC-CE, RRC, or system information (SI) message). For example, the UE 205 may have received a paging message or the UE 205 may be performing a handover procedure to the network entity 210. In this example, the UE 205 may be indicated with which RAR window configuration to use (e.g., the active RAR window configuration).

In some cases, an indicated new configuration can be active for a period time (e.g., timer-based or till the end of the modification period) or until being reconfigured or otherwise changed by the network entity 210.

Accordingly, the described techniques may support increased or delayed RAR window to allow for reception of the second RACH message (e.g., Msg2/RAR) using the gap time for network entity 210 to activate its main radio or change configuration to send the second RACH message. This may result in the waiting time for the UE 205 to increase. In some wireless networks, if the Msg1 is not received by the network entity 210 (or the second RACH message is not received by the UE 205), after expiration of the RAR window the UE 205 may attempt to initiate the RACH procedure again (e.g., be retransmitting the first RACH message). This may exacerbate the increase in access latency for the UE 205, in some cases.

Accordingly, the described technique may support an early-feedback notification that network entity 210 may have successfully received the first RACH message to the UE 205 attempting to perform the RACH procedure. In some cases, the early feedback notification may be a low-power early-feedback notification. It is to be understood that this low-power early-feedback notification is separate from the second RACH message. For example, the network entity 210 may transmit or otherwise output (and the UE 205 may receive or otherwise obtain) a low-power feedback notification that carries or otherwise conveys information that confirms receipt of the first RACH message (e.g., that the network entity 210 was able to successfully receive and decode the first RACH message). The low-power feedback notification may be transmitted after the RO and before the RAR window.

This low-power notification message may inform or otherwise notify the UE 205 whether it may or may not expect the second RACH message from the network entity 210. For example, in the absence of this notification the UE 205 may assume failure of the first RACH message and re-attempt the RACH procedure (e.g., retransmit the first RACH message during a subsequent RO) without waiting for the RAR window expiration. This technique may reduce the access delay for the UE 205 in case of failures. In some cases, the low-power feedback notification may be sent via a LP-WUT (e.g., a LP-RAR). In some cases, the network entity 210 may not need to wait the gap time to transition between NES states to send this notification. The low-power feedback notification may be sent upon detection of a preamble on the associated RO (e.g., based on simple energy detection, which may avoid involving further processing techniques or the main radio of the network entity 210). In some cases, the low-power feedback notification may be common for one or multiple RO(s) or for one or multiple preamble identifier(s) in an RO. In some cases, the low-power feedback notification may be sent or otherwise conveyed via an index modulation (easy to encode), extracted from memory, or simply putting a time domain encoder at the digital-to-analog (DAC) input at the RRH/RU (and not as now at the DU) so the notification will be very energy efficient to perform power ramping up or down.

In some cases, the low-power feedback notification may be received during a second RAR window, such as a low-power RAR (LP-RAR) window for the UE 205 to monitor. For example, a dedicated LP-RAR window (e.g., with a short duration and starting after each RO or group of ROs) may be configured by the network entity 210. For example, the network entity 210 may transmit or otherwise output (and the UE 205 may receive or otherwise obtain) information that identifies the LP-RAR window for the UE 205 to monitor for the low-power feedback notification. Upon expiration of the LP-RAR window and without receiving the low-power feedback notification, the UE 205 may assume failure and initiate a retransmission of the first RACH message. In this case, the network entity 210 may configure a low value or duration for this LP-RAR window to avoid increasing access latency.

In some cases, the low-power feedback notification may carry or otherwise convey additional information for the UE(s) performing the RACH procedure. For example, the low-power feedback notification may contain a dedicated RAR window configuration (e.g., a highly quantized starting offset or duration) for reception of second RACH message. The UE 205 may use the dedicated configuration indicated in the low-power notification message instead of the semi-static RAR window configuration(s) carried in the SIB. In some cases, this may include a narrowed down search space for the RAR physical downlink control channel (PDCCH). In some cases, the additional information may be a specific indication (e.g., an index) to an already configured RACH window configuration. In some cases, the reception of the low-power feedback notification may serve as a trigger for the start of the RAR window by UE 205.

In some cases, the network entity 210 may configure different RACH retransmission behaviors in terms of a power ramping step based on the type of expired RAR window. For example, the UE 205 may apply a power ramping operation to a retransmission of the first RACH message based on the expiration of the RAR window such that the power ramping operation may be based on the type of RAR window that has expired (e.g., a legacy RAR window type or a LP-RAR window type that starts after the RO or an extended to offset RAR window type). In some examples, the network entity 210 may transmit a system information message (e.g., an SIB) that indicates the power ramping operation for the UE 205 to apply to a retransmission of the first RACH message. As one example and for a legacy or normal RAR window type expiration, this may mean that the UE 205 was able to receive the low-power early-feedback. In this case, failure is likely due to UE 205 missing the second RACH message (e.g., the Msg2 received in a PDCCH or a physical downlink shared channel (PDSCH) rather than the network entity 210 missing the first RACH message. In this case, the network entity 210 may configure a different power ramping step (e.g., the power ramping step size may be smaller or larger if the expired RAR window is the normal RAR window type than if the expired RAR window is the LP-RAR window type).

If the LP-RAR window type has expired, this may indicate that the network entity 210 could not receive a LP-RACH. Hence, the network entity 210 may configure a different power step size for power ramping (e.g., the power ramping step size may be larger or smaller if the expired RAR window is the LP-RAR window type than if the expired RAR window is the normal RAR window type). In some cases, the power ramping operation configuration may be provided to the UE 205 via SIB, for example. In the case of a false alarm (e.g., the UE 205 receives an acknowledgement (ACK), such as the low-power feedback notification, but the ACK was meant for another UE sharing the same feedback resource for LP early-feedback) and based on the likelihood of such false alarm, the network entity 210 may configure a different step size for transmit power ramp-up in case of normal RAR window expiration or a LP-RAR window type expiration.

In some cases where the RAR window is configured with long duration, a transmit and/or receive beam of the UE 205 may change during this time. In this case, the second RACH message in the requested beam (e.g., in or associated with the beam used to transmit the first RACH message) may not be relevant anymore. In this case, the UE 205 may be required to send another LP-RACH with the updated beam before the start of the (delayed) RAR window. For example, the UE 205 may transmit or otherwise output (and the network entity 210 may receive or otherwise obtain) a second instance of the first RACH message on a second beam based on the beam change associated with the 205. The second instance of the first RACH message may be transmitted during a first RAR window that is before the RAR window (e.g., during a LP-RAR). The first RACH message may be transmitted on a first beam that is different from the second beam.

The transmission of this other LP-RACH (e.g., the second instance of the first RACH message) may be based on the condition that beam of the UE 205 has changed and/or may be indicated to the UE 205 in the low-power early feedback (e.g., the low-power early feedback notification). Additionally, or alternatively, the network entity 210 may transmit the RAR (e.g., the second RACH message) in multiple directions and/or adjacent beams. If the RAR is sent in all beams, there may be no need for further indications or signaling. If the RAR is replicated in a subset of beams, the indication to UE 205 may be provided in either the low-power early-feedback or via a SIB (e.g., semi-static configuration of subsets of beams).

In some cases, the network entity 210 may have detected collisions or congestion and, therefore, the low-power early feedback may indicate the UE 205 to perform a random backoff. In some cases, the information carried by the LP early-feedback may be encoded in sequence identifiers or code sequences or the choice of time and/or frequency resources for sending the signal.

In some RACH adaptations related to NES operations, the network entity 210 may configure infrequent ROs to achieve NES. Additional ROs may be activated (e.g., dynamically) if the network entity 210 detects collisions or predicts more UEs may perform access via a RACH procedure. Accordingly, the described techniques may support extension of the techniques discussed herein to the case of RACH adaptation for NES operations. For example, additional ROs may be configured with different RAR configuration compared to the baseline ROs. That is, the RAR window configuration(s) may include a threshold RO density (e.g., an increased RO density where the additional ROs are activated).

In some cases, the first RACH message may be a Msg1-based OD-SIB1 or OD-other system information (OSI) request where the network entity 210 replies with an ACK or Msg2 following the RACH procedure with legacy RAR window configuration. In the case where network entity 210 also received the OD-SIB1 or OD-OSI request using its low-power receiver, the network entity 210 may send this ACK using a low-power signal design (e.g., support the ACK for the OD-SIB1 or OD-OSI request using the low-power early-feedback). That is, the first RACH message may be an on-demand system information message (e.g., OD-SIB1 or OD-OSI) and the network entity 210 may transmit or otherwise output (and the UE 205 may receive or otherwise obtain) a low-power feedback notification that acknowledges the request for the OD system information message. In this case, the low-power early-feedback message may replace the legacy RACH Msg2. The network entity 210 may configure a delayed, different, or dedicated monitoring window for the triggered OD-SIB1/OD-OSI request. This window may be semi-statically configured and signaled in SIB (or with other RACH parameters).

In some cases, the described techniques may provide support for proactive indication of upcoming UE traffic to the network entity 210 so that the network entity 210 may turn on its main radio or assume a better transmit/receive configuration of its components. The UE 205 may predict upcoming downlink and/or uplink traffic (e.g., using machine learning or artificial intelligence (AI) modeling) and signal this information to the network entity 210. For example, the UE 205 may transmit or otherwise output (and the 210 may receive or otherwise obtain) a low-power uplink wakeup signal that identifies an uplink traffic pattern and/or a downlink traffic pattern during an upcoming time window. The network entity 210 may use this information to power on its main radio or transition to a better configuration) for the upcoming traffic. In some cases, the indication of the upcoming traffic pattern(s) may be provided via a LP-UL-WUS. For example, the indication can carry information about the likelihood of UE’s downlink and/or uplink traffic pattern(s) in the next window. The mapping from multiple ranges of likelihoods to the LP-UL-WUS resources and/or configurations and the configuration of upcoming window duration may be provided to the UE 205. In some cases, the network entity 210 may use its low-power receive radio or operating mode to receive LP-UL-WUS.

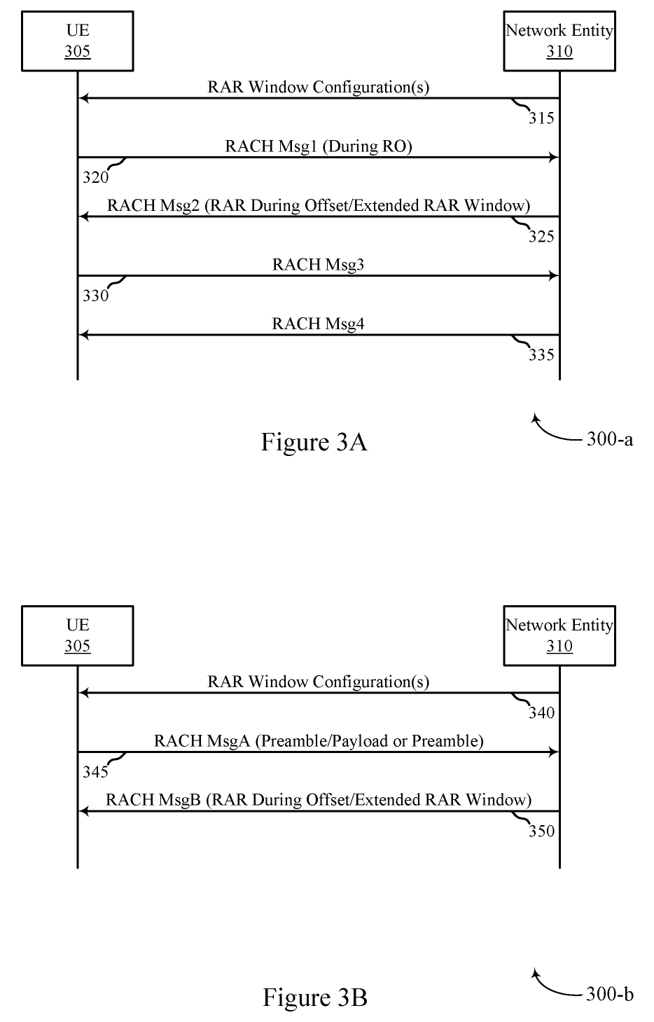

FIGS. 3A and 3B show examples of a diagram 300 that supports RACH enhancements for NES operations. Aspects of the diagram 300 may be implemented by or may implement aspects of the wireless communications system 100 or aspects of the signaling configuration 200. Aspects of the diagram 300 may be implemented at or implemented by a UE 305 and a network entity 310, which may be examples of the corresponding devices described herein. The diagram 300-a of FIG. 3A illustrates an example of the described techniques in a four-step RACH procedure and the diagram 300-b of FIG. 3B illustrates an example of the described techniques in a two-step RACH procedure.

Turning first to the diagram 300-a of FIG. 3A, at 315 the network entity 310 may transmit or otherwise output (and the UE 305 may receive or otherwise obtain) a signal that identifies RAR window configuration(s). One, some, or all of the RAR window configurations may identify or otherwise configure a RAR window offset and/or an extended RAR window duration for a RAR window corresponding to a RO. The signal identifying the RAR window configuration(s) may be a SIB message (e.g., a SIB1), RRC signaling, MAC-CE signaling, or broadcast, multicast, or unicast signaling mechanisms. In some cases, the RAR window configuration(s) are included as part of RACH configuration(s) signaled to the UE 305 (e.g., be included as one or more parameters, information element(s) (IE)(s), or other information included in the RACH configuration).

At 320, the UE 305 may transmit or otherwise output (and the network entity 310 may receive or otherwise obtain) a first RACH message to initiate a RACH procedure for the UE 305. In this four-step RACH procedure example, the first RACH message is a RACH Msg1. The first RACH message may be transmitted during a RO. The RO may be part of the RACH configuration signaled to the UE 305 where the UE 305 selects a RO to transmit the first RACH message according to the RAR window configuration.

At 325, the network entity 310 may transmit or otherwise output (and the UE 305 may monitor for, receive, or otherwise obtain) a second RACH message associated with the first RACH message according to the RAR window configuration. For example, the second RACH message may be transmitted during the RAR window that is associated with or otherwise corresponds to the RO that the first RACH message was transmitted in. The RAR window in this example may be offset relative to the RO and/or may be extended in duration. For example, the RAR window may be offset and/or extended in duration based on the network entity 310 operating in a NES mode or state (e.g., in a sleep state or mode). In some aspects, the second RACH message may be a RAR message that includes information, such as a timing advance command for timing adjustments, a random access preamble identifier that matches the preamble sent in the first RACH message, and an initial uplink grant for the UE 305.

At 330, the UE 305 may transmit or otherwise output (and the network entity 310 may receive or otherwise obtain) a third RACH message. In this four-step RACH procedure example, the third RACH message may include a RACH message three (Msg3). In some aspects, the third RACH message may use the uplink grant provided in the second RACH message and may be transmitted via a physical uplink shared channel (PUSCH). The third RACH message may carry or otherwise convey data (e.g., physical layer data) and/or RRC message information (e.g., such as an RRC resume message or other RRC signaling).

At 335, the network entity 310 may transmit or otherwise output (and the UE 305 may receive or otherwise obtain) a fourth RACH message. In this four-step RACH procedure example, the fourth RACH message may include a RACH message four (Msg4). The fourth RACH message may include MAC data used for contention resolution (in some cases), such as an identifier of the UE 305.

Turning next to the diagram 300-b of FIG. 3B, at 340 the network entity 310 may transmit or otherwise output (and the UE 305 may receive or otherwise obtain) a signal that identifies RAR window configuration(s). One, some, or all of the RAR window configurations may identify or otherwise configure a RAR window offset and/or an extended RAR window duration for a RAR window corresponding to a RO. The signal identifying the RAR window configuration(s) may be a SIB message (e.g., a SIB1), RRC signaling, MAC-CE signaling, or broadcast, multicast, or unicast signaling mechanisms. In some cases, the RAR window configuration(s) are included as part of RACH configuration(s) signaled to the UE 305 (e.g., be included as one or more parameters, information element(s) (IE)(s), or other information included in the RACH configuration).

At 345, the UE 305 may transmit or otherwise output (and the network entity 310 may receive or otherwise obtain) a first RACH message to initiate the RACH procedure for the UE 305. In this two-step RACH procedure example, the first RACH message may include a MsgA. The first RACH message may be transmitted during a RO (e.g., as identified in part of the RAR window configuration or the RACH configuration that includes the RAR window configuration).

At 350, the network entity 310 may transmit or otherwise output (and the UE 305 may monitor for, receive, or otherwise obtain) a second RACH message associated with the first RACH message and according to the RAR window configuration. For example, the second RACH message may be transmitted during a RAR window that corresponds to the RO. In this two-step RACH procedure example, the second RACH message may include a MsgB.

Accordingly, the diagram 300-b of FIG. 3B may extend the techniques described herein to the two-step RACH procedure. In some aspects, two different sub-cases may be defined. The first case is that the low-power radio or operating mode of the network entity 310 is used monitoring for both ROs and PUSCH occasions (POs) for the MsgA preamble and MsgA payload, respectively. In this case, the techniques described herein may apply to the MsgB response window (e.g., needing a larger window to account for the gap times). Different starting offset(s) and/or duration(s) may be configured and associated to one or many RO(s) and corresponding PO(s). This may support, for example, multiple MsgBs being sent in the same burst. In one example, to allow for more simple processing of the MsgA payload, a simpler time-domain waveform and/or sequence may be used instead of PUSCH. Additional information may be shared by the UE 305 at a later stage when the main radio of the network entity 310 is active. Accordingly, in this case the UE 305 may transmit the RACH MsgA preamble during the RO and transmit the RACH MsgA payload during a PO.

In a second case, the low-power radio and/or operating mode of the network entity 310 may monitor the ROs (e.g., for the RACH MsgA preamble). In this case, the network entity 310 may activate its main radio or higher power consumption mode to monitor PUSCH on or during POs. That is, the UE 305 may transmit the RACH MsgA preamble during the RO in this case. The network entity 310 may configure a larger time interval between ROs and the corresponding POs to account for power ramping and/or the gap time. In some aspects, a similar consideration for the RACH MsgB window may be applied in this case. This case may support switching between the two cases across beams, SSBS, ROs and/or time and the required signaling.

In some cases, the early feedback indication may be used to help the UE 305 reduce access latency in the case of increased RACH MsgB window duration. In the first case, the early feedback may be sent after the network entity 310 has received the RACH MsgA preamble and/or the RACH MsgA payload. A separate low-power MsgB may be configured for this purpose. A separate low-power MsgB window may also be configured by the network entity 310. In the second case, the early feedback may be sent after the network entity 310 has detected the RACH MsgA preamble transmission. Absent this early feedback, the UE 305 may not send the corresponding RACH MsgA payload. Accordingly, the network entity 310 may transmit or otherwise output (and the UE 305 may receive or otherwise obtain) a low-power feedback notification that confirms receipt of the RACH MsgA. The low-power feedback notification may be transmitted after the RO and before the RAR window.

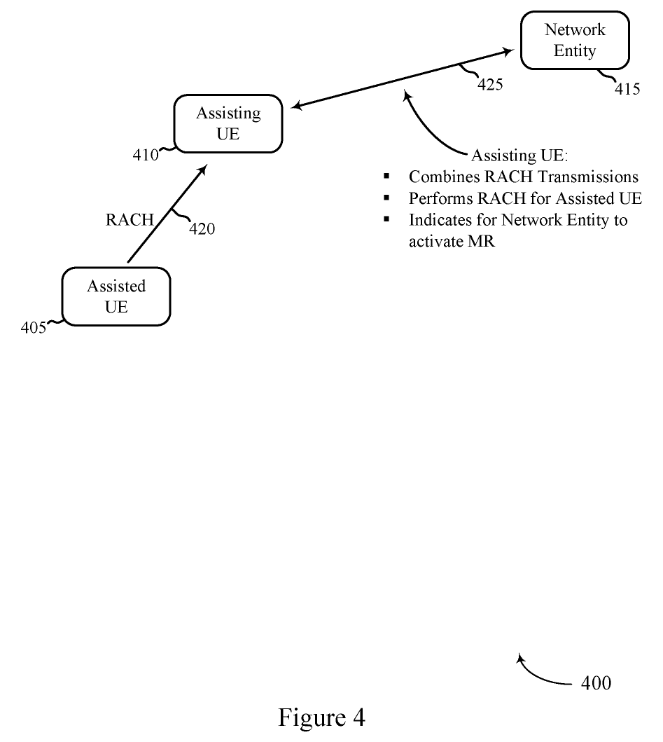

FIG. 4 shows an example of a signaling configuration 400 that supports RACH enhancements for NES operations. Aspects of the signaling configuration 400 may be implemented at or may implement aspects of the wireless communications system 100, aspects of the signaling configuration 200, and/or aspects of the diagram 300. Aspects of the signaling configuration 400 may be implemented at or implemented by an assisted UE 405, an assisting UE 410, and a network entity 415, which may be examples of the corresponding devices described herein.

As discussed above, the techniques described herein provide for improved RACH operations for UE while supporting NES operations of the network. This may include a network entity transmitting a signal to UE(s) that identify RAR window configuration(s) associated with RACH procedures for the UE. One, a subset, or all of the RAR window configurations may identify a RAR window offset and/or an extended RAR window duration for a RAR window corresponding to a RO. The UE may transmit a first RACH message during a RO to initiate the RACH procedure for the UE and then monitor for a second RACH message during the corresponding RAR window.

Aspects of the signaling configuration 400 illustrate an example where the described techniques are extended to a UE collaboration scenario. For example, the assisted UE 405 and the assisting UE 410 may be collaborating with respect to each other. That is, receiving the RACH (e.g., the first RACH message) while the network entity 415 is using its low-power radio or otherwise operating in a low-power mode may be problematic in some scenarios (e.g., subject to a high failure probability, increased access latency, due to the lower processing capabilities of low-power operating mode or radio). In the UE collaboration scenario, multiple spatially co-located UEs may collaborate in certain network procedures, which may include the RACH procedure.

In some cases, this may be based on the network entity 415 operating in a low-power mode or using its low-power radio to monitor common channels (e.g., NES operations). There may be UEs with reduced capabilities or bad link budget within the cooperation group attempting to perform a RACH procedure, which may amplify these problems since the network entity 415 is in the low-power radio or operating mode). In some cases, the cooperating UEs may be associated with the same user (e.g., a smartwatch, extended reality (XR) headset, etc.) or belong to different users. The local communication link between the collaborating UE may be a sidelink connection, a Bluetooth connection, a Wi-Fi connection, or a connection using other technologies.

In this example, the assisted UE 405 and the assisting UE 410 may be collaborating UEs where the assisting UE 410 assists the assisted UE 405 with such network functions. Accordingly, in some aspects the assisting UE 410 (e.g., the UE with the more-capable or better link budget) can assist facilitate the access (e.g., the RACH procedure) for the less-capable or worse link budget UE(s) (e.g., the assisted UE 405, in this example) in the cooperation group when the network entity 415 is using its low-power radio and/or low-power operating mode.

Several types of collaboration may be included. A first type of collaboration may include the collaborating UEs exploiting a single frequency network (SFN) by combining their RACH transmissions to increase the chances of a successful reception by the network entity 415. For example, the UE may transmit its first RACH message via the SFN in conjunction with other first RACH message transmission(s) that are transmitted by collaborating UE(s). As discussed, the collaborating UEs may be associated with each other (e.g., the same user) or may be associated with different users.

Another type of collaboration may include the assisting UE 410 performing RACH on behalf of the less capable or low link budget assisted UEs (e.g., the assisted UE 405, in this example). For example, at 420 this may include the assisted UE 405 transmitting its first RACH message to the assisting UE 410 where, at 425, the assisting UE 410 forwards the first RACH message to the network entity 415. As another example and from the perspective of the assisting UE 410, at 420 this may include the assisting UE 410 receiving the first RACH message from the assisted UE 405 and, at 425, the assisting UE 410 transmitting the first RACH message to the network entity 415. In some aspects, these RACH transmissions may be performed or otherwise associated with a low-power RACH and optionally include multiple transmissions of the first RACH message.

Another type of collaboration may include the assisting UE 410 indicating to the network entity 415 to change its receive configuration and/or operating mode (e.g., to activate its main radio). This indication can be transmitted via a LP-UL-WUS or a proactive LP-UL-WUS (e.g., triggered by expected upcoming uplink traffic by one or more other UEs). In some cases, the network entity 415 may answer (e.g., respond) to this indication with an ACK signal. The network entity 415 may indicate or otherwise configure the assisting UE 410 with a waiting-timer (to account for power ramping/gap times). Upon expiration of this timer, the assisting UE 410 may trigger the assisted UE 405 to perform RACH transmissions towards the network entity 415. In some cases, this indication may be transmitted via a local communication link for the collaborating group of UEs. Additionally, or alternatively, the assisting UE 410 may broadcast the value for this timer and the assisted UE 405 may wait for its expiration before performing the RACH transmission. In some case, the assisting UE 410 may be operating in an idle or inactive mode and may be triggered by the assisted UE 405 wanting to perform RACH (e.g., the initiate the RACH procedure for the assisted UE 405). Accordingly, in some cases the first RACH message or some other message may identify a request for the network entity 415 to transition to an active state (e.g., to turn on its main radio and/or otherwise transition to an active or awake state or operating mode).

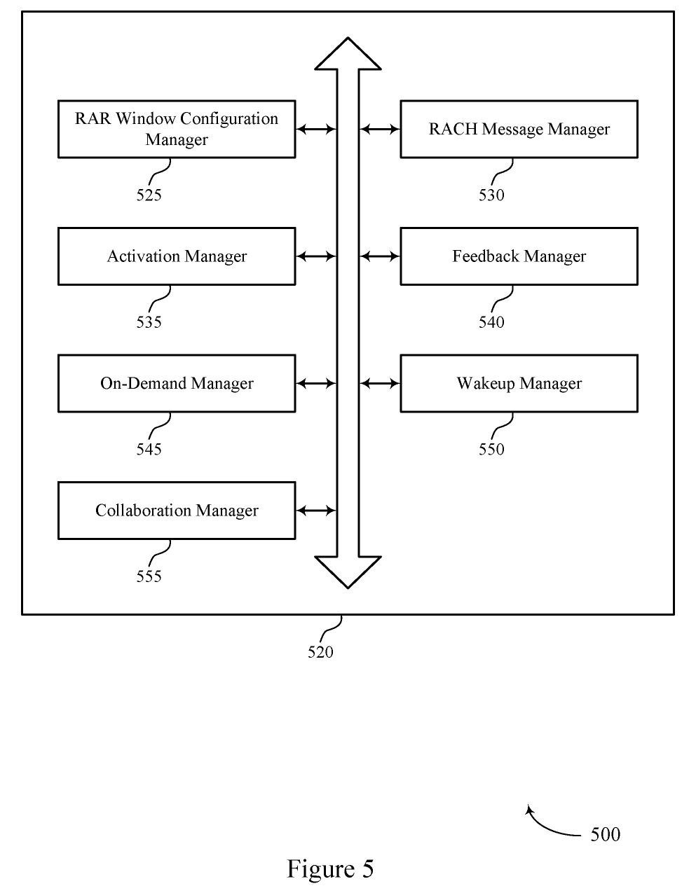

FIG. 5 shows an example of a processing system 520 that supports RACH enhancements for NES operations. A processing system 520 may be an example of a processing system 140 (such as of a UE 115) and may include a RAR window configuration manager 525, a RACH message manager 530, an activation manager 535, a feedback manager 540, an on-demand manager 545, a wakeup manager 550, a collaboration manager 555, or any combination thereof. A processing system 520, or various component thereof, may be an example of means for performing (such as a means for causing a UE 115 to perform) various techniques described herein.

The RAR window configuration manager 525 may be configured to cause the UE 115 to receive a signal that identifies a random access response (RAR) window configuration associated with a RACH procedure for the UE, where the RAR window configuration identifies a RAR window offset and an extended RAR window duration for a RAR window corresponding to a RACH occasion. The RACH message manager 530 may be configured to cause the UE 115 to transmit, during the RACH occasion, a first RACH message to initiate the RACH procedure for the UE. In some examples, the RACH message manager 530 may be configured to cause the UE 115 to monitor, during the RAR window corresponding to the RACH occasion, for a second RACH message associated with the first RACH message according to the RAR window configuration. In some examples, the RAR window offset includes a starting symbol offset, a starting slot offset, a system frame number (SFN) offset, or any combination thereof, between an end of the RACH occasion and the RAR window. In some examples, the RAR window configuration is based on a NES operating mode of a network entity associated with the UE.

In some examples, the activation manager 535 may be configured to cause the UE 115 to receive an activation signal that activates the RAR window configuration to be used for the RACH procedure for the UE from among a set of multiple RAR window configurations that include the RAR window configuration.

In some examples, the feedback manager 540 may be configured to cause the UE 115 to receive, after the RACH occasion and before the RAR window, a feedback notification that confirms receipt of the first RACH message, where the feedback notification is different from the second RACH message. In some examples, the feedback manager 540 may be configured to cause the UE 115 to receive information that identifies a second RAR window for the UE to monitor for the feedback notification.

In some examples, the feedback manager 540 may be configured to cause the UE 115 to transmit, during a first RAR window that is before the RAR window, a second instance of the first RACH message on a second beam based on a beam change associated with the UE, where the first RACH message is transmitted on a first beam that is different from the second beam. In some examples, the feedback manager 540 may be configured to cause the UE 115 to apply a power ramping operation to a retransmission of the first RACH message based on an expiration of the RAR window, where the power ramping operation is based on a type of RAR window that has expired. In some examples, the RAR window configuration includes a threshold RACH occasion density. In some examples, the first RACH message includes a RACH message A and the second RACH message includes a RACH message B. In some examples, the UE transmits a RACH message A preamble during the RACH occasion and transmits a RACH message A payload during an PUSCH occasion. In some examples, the UE transmits a RACH message A preamble during the RACH occasion.

In some examples, the feedback manager 540 may be configured to cause the UE 115 to receive, after the RACH occasion and before the RAR window, a feedback notification that confirms receipt of the RACH message A.

In some examples where the first RACH message includes a request for an on-demand system information message, the on-demand manager 545 may be configured to cause the UE 115 to receive a feedback notification that acknowledges the request for the on-demand system information message.

In some examples, the wakeup manager 550 may be configured to cause the UE 115 to transmit a low-power uplink wakeup signal that identifies an uplink traffic pattern during an upcoming time window. In some examples, the first RACH message is transmitted to an assisting UE to be forwarded to a network entity.

In some examples, the collaboration manager 555 may be configured to cause the UE 115 to receive the first RACH message from an assisted UE, where the UE includes an assisting UE associated with the assisted UE and transmitting the first RACH message includes forwarding the first RACH message from the assisted UE to a network entity. In some examples, the first RACH message identifies a request for the network entity to transition to an active state.

In some examples, the first RACH message is transmitted via a single frequency network (SFN) in conjunction with one or more other first RACH messages transmitted by a collaborating UE that is associated with the UE.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for improved RACH procedures to support NES operations at the network. The delayed or extended RAR windows may provide for reliable RACH procedures by the UE while enabling the NES operations at the network.

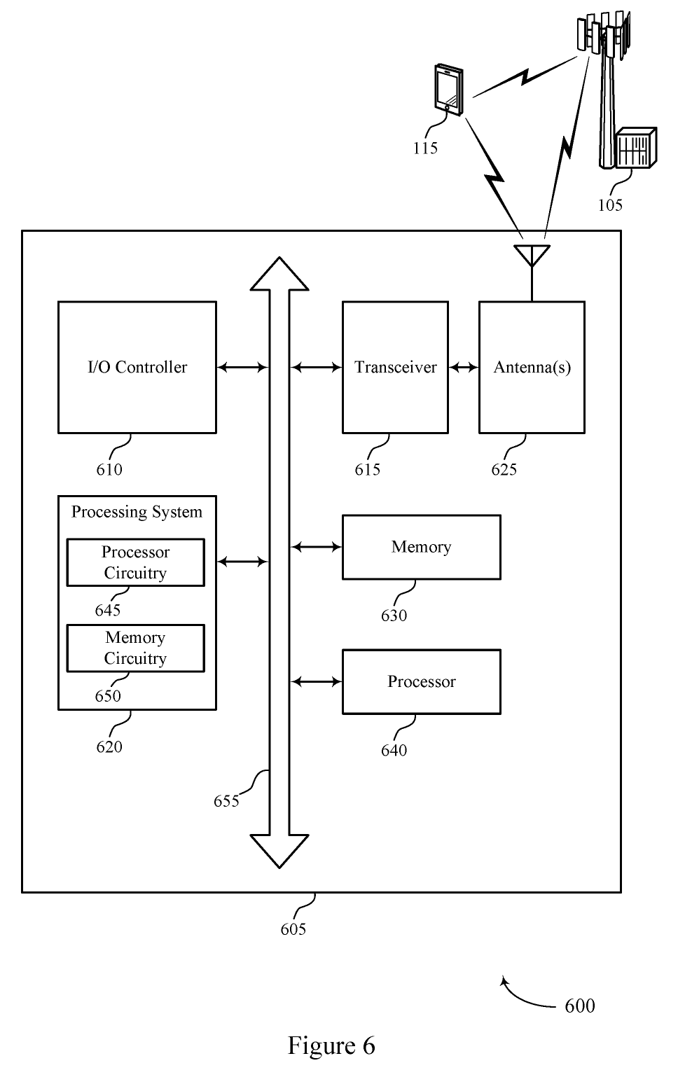

FIG. 6 shows an example of a system 600 including a device 605 that supports RACH enhancements for NES operations. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed (e.g., directly, indirectly, after pre-processing, without pre-processing) by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 500. For example, the processing system 620 may include processor circuitry 645 and memory circuitry 650 that stores code, and may be configured to cause the device 605 to perform operations that support RACH enhancements for NES operations. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for improved RACH procedures to support NES operations at the network. The delayed or extended RAR windows may provide for reliable RACH procedures by the UE while enabling the NES operations at the network.

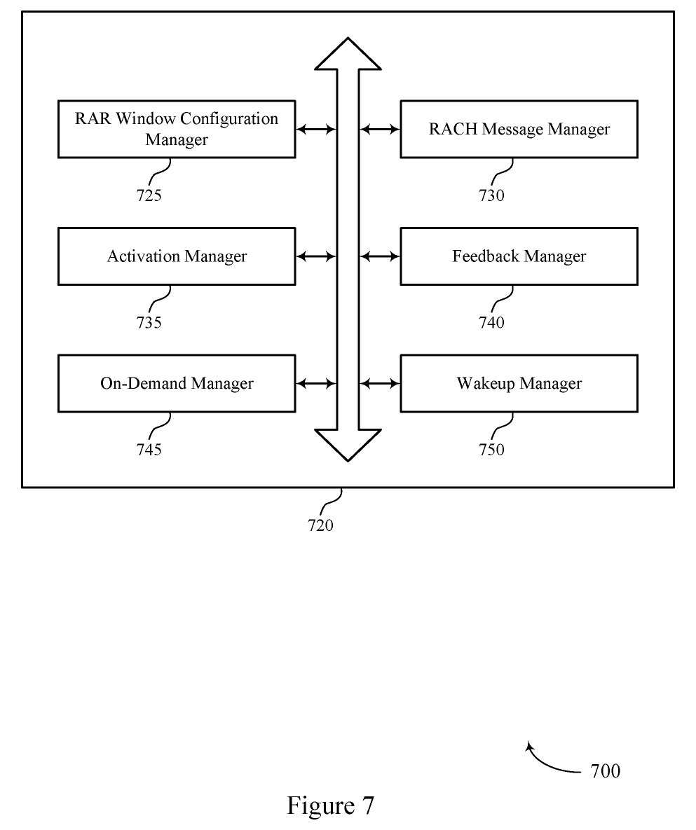

FIG. 7 shows an example of a processing system 720 that supports RACH enhancements for NES operations. A processing system 720 may be an example of a processing system 145 (such as network entity 105) and may include a RAR window configuration manager 725, a RACH message manager 730, an activation manager 735, a feedback manager 740, an on-demand manager 745, a wakeup manager 750, or any combination thereof. A processing system 720, or various component thereof, may be an example of means for performing (such as a means for causing a network entity 105 to perform) various techniques described herein.

The RAR window configuration manager 725 may be configured to cause the network entity 105 to transmit, to a UE, a signal that identifies a random access response (RAR) window configuration associated with a RACH procedure for the UE, where the RAR window configuration identifies a RAR window offset and an extended RAR window duration for a RAR window corresponding to a RACH occasion. The RACH message manager 730 may be configured to cause the network entity 105 to receive, from the UE and during the RACH occasion, a first RACH message to initiate the RACH procedure for the UE. In some examples, the RACH message manager 730 may be configured to cause the network entity 105 to transmit, to the UE during the RAR window corresponding to the RACH occasion, a second RACH message associated with the first RACH message according to the RAR window configuration.

In some examples, the RAR window offset includes a starting symbol offset, a starting slot offset, a system frame number (SFN) offset, or any combination thereof, between an end of the RACH occasion and the RAR window. In some examples, the RAR window configuration is based on a NES operating mode of the network entity associated with the UE.

In some examples, the activation manager 735 may be configured to cause the network entity 105 to transmit, to the UE, an activation signal that activates the RAR window configuration to be used for the RACH procedure for the UE from among a set of multiple RAR window configurations that include the RAR window configuration.

In some examples, the feedback manager 740 may be configured to cause the network entity 105 to transmit, to the UE after the RACH occasion and before the RAR window, a feedback notification that confirms receipt of the first RACH message, where the feedback notification is different from the second RACH message. In some examples, the feedback manager 740 may be configured to cause the network entity 105 to transmit, to the UE, information that identifies a second RAR window for the UE to monitor for the feedback notification.

In some examples, the feedback manager 740 may be configured to cause the network entity 105 to receive, from the UE and during a first RAR window that is before the RAR window, a second instance of the first RACH message on a second beam based on a beam change associated with the UE, where the first RACH message is received on a first beam that is different from the second beam. In some examples, the feedback manager 740 may be configured to cause the network entity 105 to transmit, to the UE, a system information message that indicates a power ramping operation for the UE to apply to a retransmission of the first RACH message based on an expiration of the RAR window, where the power ramping operation is based on a type of RAR window that has expired. In some examples, the RAR window configuration includes a threshold RACH occasion density. In some examples, the first RACH message includes a RACH message A and the second RACH message includes a RACH message B. In some examples, the network entity receives a RACH message A preamble during the RACH occasion and receives a RACH message A payload during an PUSCH occasion. In some examples, the network entity receives a RACH message A preamble during the RACH occasion.

In some examples, the feedback manager 740 may be configured to cause the network entity 105 to transmit, to the UE after the RACH occasion and before the RAR window, a feedback notification that confirms receipt of the RACH message A.

In some examples where the first RACH message includes a request for an on-demand system information message, the on-demand manager 745 may be configured to cause the network entity 105 to transmit, to the UE, a feedback notification that acknowledges the request for the on-demand system information message.

In some examples, the wakeup manager 750 may be configured to cause the network entity 105 to receive, from the UE, a low-power uplink wakeup signal that identifies an uplink traffic pattern during an upcoming time window. In some examples, the first RACH message is received from an assisting UE to be forwarded to the network entity for an assisted UE. In some examples, the UE includes the assisting UE. In some examples, the network entity receives the first RACH message from the UE. In some examples, the first RACH message identifies a request for the network entity to transition to an active state. In some examples, the first RACH message is received via a single frequency network (SFN) in conjunction with one or more other first RACH messages transmitted by a collaborating UE that is associated with the UE.

A processing system 720 may include or be an example of one or more chips, SoCs, chipsets, packages, components, or devices that individually or collectively constitute or include a processing system. A processing system 720 may interface with other components of a network entity 105. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a network entity 105). Operations described herein with reference to the processing system 720, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 720 for operation in a processing system 720 as described herein, the processing system 720 may support techniques for improved RACH procedures to support NES operations at the network. The delayed or extended RAR windows may provide for reliable RACH procedures by the UE while enabling the NES operations at the network.

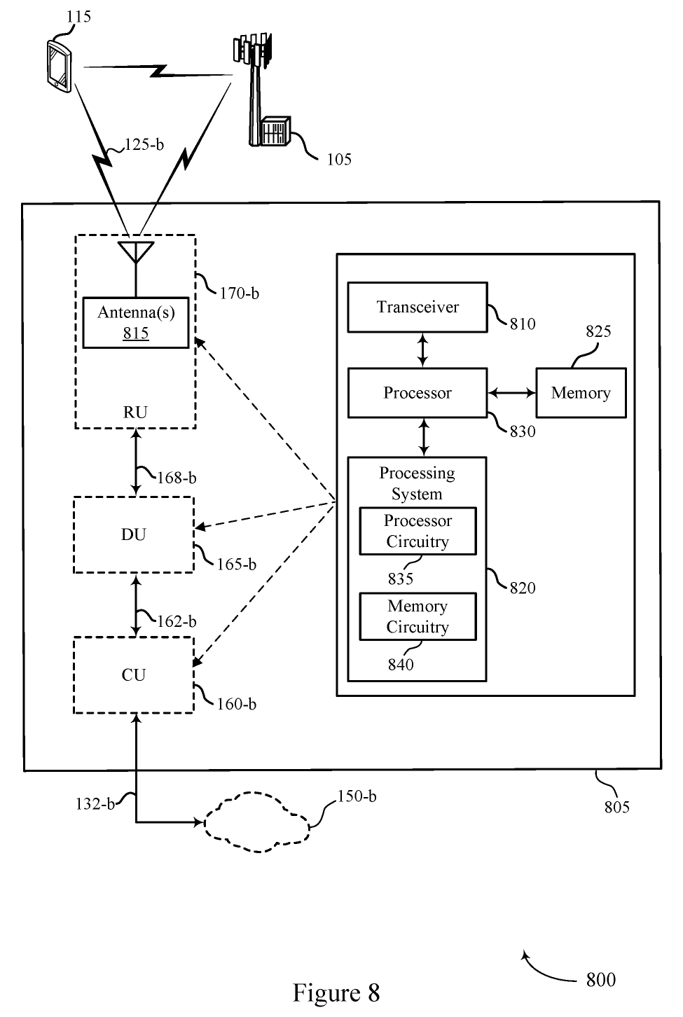

FIG. 8 shows an example of a system 800 including a device 805 that supports RACH enhancements for NES operations. The device 805 may communicate (such as via one or more wired interfaces or one or more wireless interfaces) with other network devices or network equipment such as a core network 150-b, other network entities 105, UEs 115, or any combination thereof. The device 805 may include components for transmitting and receiving communication, which may include a processing system 820, a transceiver 810, antenna(s) 815, a memory 825, and a processor 830. Components of the device 805 may be coupled (such as operatively, communicatively, functionally, electronically, electrically, in electronic communication) via one or more interfaces.

The transceiver 810 may communicate bi-directionally with another transceiver via wired or wireless links, and may support transmission operations, reception operations, or both, as described herein. The transceiver 810 may include a modem to modulate and demodulate signals, to provide the modulated signals for transmission (such as via antenna(s) 815, via a wired interface), and to demodulate received signals (such as received via antenna(s) 815, received via a wired interface). The transceiver 810 may be operable to support communication via one or more communication links (such as a communication link 125-b, a backhaul link 132-b, a midhaul link 162-b, fronthaul link 168-b).

The processor 830 may be a general-purpose processing component that supports various operations (such as applications) of the device 805. The memory 825 may be a general-purpose storage component that stores code executable by the processor 830. Such code may include instructions that, when executed (e.g., directly, indirectly, after pre-processing, without pre-processing) by the processor 830, cause the device 805 to perform various functions (such as to support an application of the device 805).

For examples in which the device 805 is a network entity 105 in a disaggregated architecture, one or more components of the device 805 may be located at one or more of a CU 160-b, a DU 165-b, or an RU 170-b, one or more of which may include aspects of the processing system 820, the processor 830, the memory 825, or the transceiver 810. Functions of the device 805 may be performed at different components or an operation may be divided between different components (such as different functions being supported by aspects of the CU 160-b, the DU 165-b, or the RU 170-b, the transceiver 810, the processor 830, the memory 825, the processing system 820, or any combination thereof). For example, the processing system 820 may be a component of one or more of the CU 160-b, the DU 165-b, or the RU 170-b. In some examples, interfaces between components of device 805 (such as CU 160-b, DU 165-b, RU 170-b) may support communication at a protocol layer or between protocol layers of a protocol stack.

In some examples, the processing system 820 may manage aspects of communication with the core network 150-b (such as via a backhaul link 132). For example, the processing system 820 may manage the transfer of data communication for UEs 115 with a gateway of the core network 150-b. In some examples, the processing system 820 may manage communication with one or more other network entities 105 and may include a controller or scheduler for controlling communication with UEs 115 (such as in cooperation with the one or more other network entities 105). In some examples, the processing system 820 may support an interface (such as X2 interface, Xn interface) to provide communication between network entities 105.

The processing system 820 may be an example of a processing system 145 or a processing system 700. For example, the processing system 820 may include processor circuitry 835 and memory circuitry 840 that stores code, and the processing system 820 may be configured to cause the device 805 to perform operations that support RACH enhancements for NES operations. Although the processing system 820 is illustrated as a separate component, which may involve a separate chip, chipset, or other module, in some implementations, one or more functions described with reference to the processing system 820 may be supported by or performed by a transceiver 810, antenna(s) 815, a processor 830, memory 825, or any combination thereof, such that a processing system 820 may include one or more of a transceiver 810, antenna(s) 815, a processor 830, memory 825, or any combination thereof. Further, processor circuitry 835 and memory circuitry 840 each may be implemented at the device 805 in accordance with an aggregated architecture, or the processor circuitry 835 and the memory circuitry 840 may be implemented at one or more of a CU 160-b, a DU 165-b, or an RU 170-b in accordance with a disaggregated architecture.

By including or configuring the processing system 820 for operation in the device 805 as described herein, may support techniques for improved RACH procedures to support NES operations at the network. The delayed or extended RAR windows may provide for reliable RACH procedures by the UE while enabling the NES operations at the network.

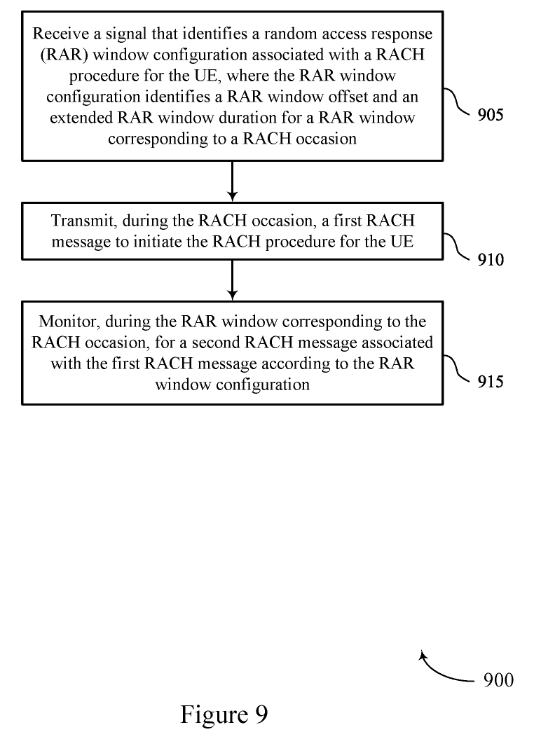

FIG. 9 shows an example of a method 900 that supports RACH enhancements for NES operations. Operations of the method 900 may be performed by a UE or its components (such as using a processing system configured to cause the UE 115 to perform one or more of the operations) as described herein.

At 905, the method may include receiving a signal that identifies a RAR window configuration associated with a RACH procedure for the UE, where the RAR window configuration identifies a RAR window offset and an extended RAR window duration for a RAR window corresponding to a RACH occasion. In some examples, aspects of the operations of 905 may be performed by a RAR window configuration manager 525.

At 910, the method may include transmitting, during the RACH occasion, a first RACH message to initiate the RACH procedure for the UE. In some examples, aspects of the operations of 910 may be performed by a RACH message manager 530.

At 915, the method may include monitoring, during the RAR window corresponding to the RACH occasion, for a second RACH message associated with the first RACH message according to the RAR window configuration. In some examples, aspects of the operations of 915 may be performed by a RACH message manager 530.

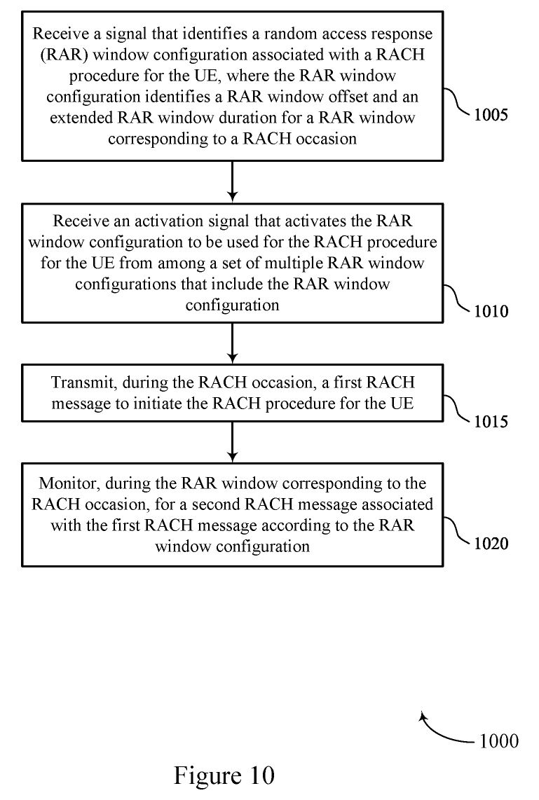

FIG. 10 shows an example of a method 1000 that supports RACH enhancements for NES operations. Operations of the method 1000 may be performed by a UE or its components (such as using a processing system configured to cause the UE 115 to perform one or more of the operations) as described herein.

At 1005, the method may include receiving a signal that identifies a RAR window configuration associated with a RACH procedure for the UE, where the RAR window configuration identifies a RAR window offset and an extended RAR window duration for a RAR window corresponding to a RACH occasion. In some examples, aspects of the operations of 1005 may be performed by a RAR window configuration manager 525.

At 1010, the method may include receiving an activation signal that activates the RAR window configuration to be used for the RACH procedure for the UE from among a set of multiple RAR window configurations that include the RAR window configuration. In some examples, aspects of the operations of 1010 may be performed by an activation manager 535.

At 1015, the method may include transmitting, during the RACH occasion, a first RACH message to initiate the RACH procedure for the UE. In some examples, aspects of the operations of 1015 may be performed by a RACH message manager 530.

At 1020, the method may include monitoring, during the RAR window corresponding to the RACH occasion, for a second RACH message associated with the first RACH message according to the RAR window configuration. In some examples, aspects of the operations of 1020 may be performed by a RACH message manager 530.

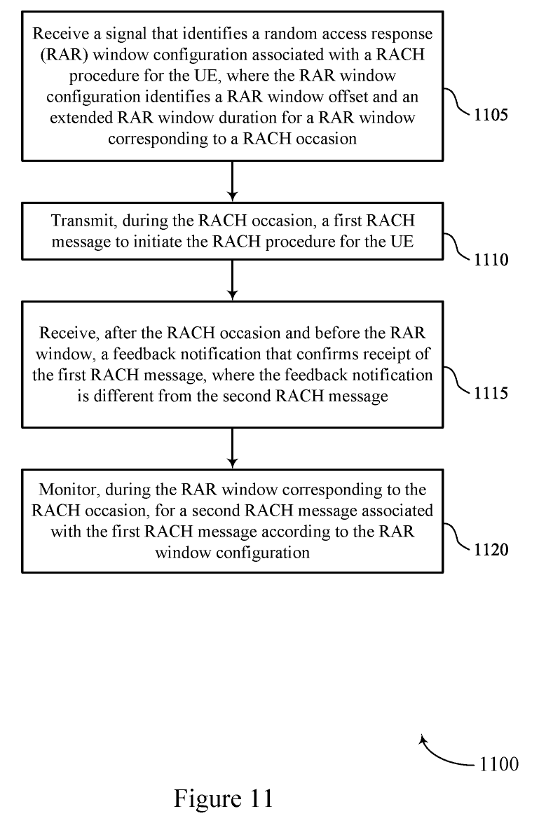

FIG. 11 shows an example of a method 1100 that supports RACH enhancements for NES operations. Operations of the method 1100 may be performed by a UE or its components (such as using a processing system configured to cause the UE 115 to perform one or more of the operations) as described herein.

At 1105, the method may include receiving a signal that identifies a RAR window configuration associated with a RACH procedure for the UE, where the RAR window configuration identifies a RAR window offset and an extended RAR window duration for a RAR window corresponding to a RACH occasion. In some examples, aspects of the operations of 1105 may be performed by a RAR window configuration manager 525.

At 1110, the method may include transmitting, during the RACH occasion, a first RACH message to initiate the RACH procedure for the UE. In some examples, aspects of the operations of 1110 may be performed by a RACH message manager 530.

At 1115, the method may include receiving, after the RACH occasion and before the RAR window, a feedback notification that confirms receipt of the first RACH message, where the feedback notification is different from the second RACH message. In some examples, aspects of the operations of 1115 may be performed by a feedback manager 540.

At 1120, the method may include monitoring, during the RAR window corresponding to the RACH occasion, for a second RACH message associated with the first RACH message according to the RAR window configuration. In some examples, aspects of the operations of 1120 may be performed by a RACH message manager 530.

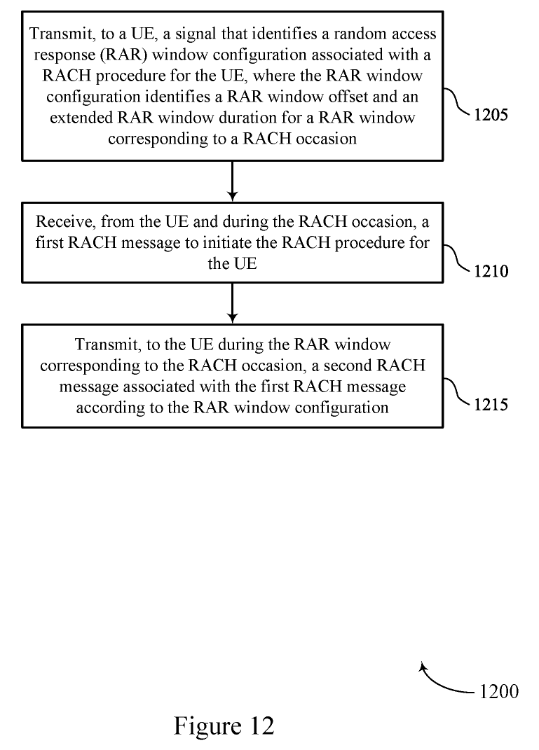

FIG. 12 shows an example of a method 1200 that supports RACH enhancements for NES operations. Operations of the method 1200 may be performed by a network entity 105 or its components (such as using a processing system configured to cause the network entity to perform one or more operations) as described herein.

At 1205, the method may include transmitting, to a UE, a signal that identifies a RAR window configuration associated with a RACH procedure for the UE, where the RAR window configuration identifies a RAR window offset and an extended RAR window duration for a RAR window corresponding to a RACH occasion. In some examples, aspects of the operations of 1205 may be performed by a RAR window configuration manager 725.

At 1210, the method may include receiving, from the UE and during the RACH occasion, a first RACH message to initiate the RACH procedure for the UE. In some examples, aspects of the operations of 1210 may be performed by a RACH message manager 730.

At 1215, the method may include transmitting, to the UE during the RAR window corresponding to the RACH occasion, a second RACH message associated with the first RACH message according to the RAR window configuration. In some examples, aspects of the operations of 1215 may be performed by a RACH message manager 730.

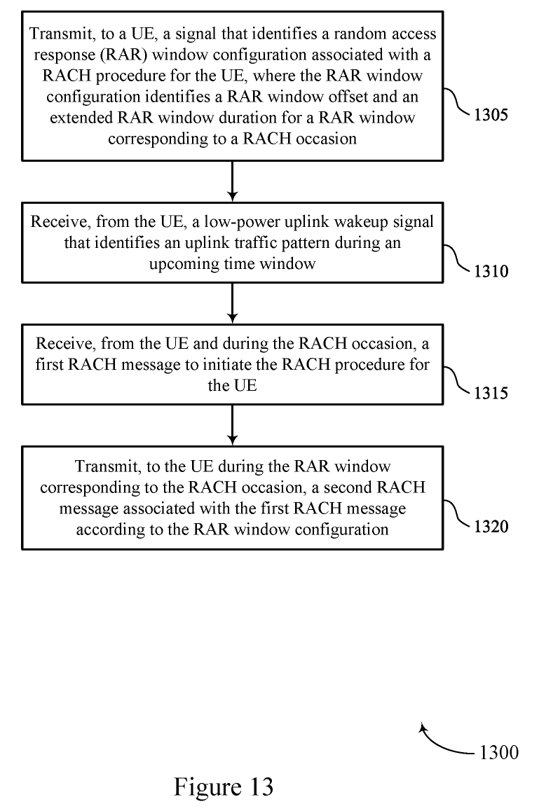

FIG. 13 shows an example of a method 1300 that supports RACH enhancements for NES operations. Operations of the method 1300 may be performed by a network entity 105 or its components (such as using a processing system configured to cause the network entity to perform one or more operations) as described herein.

At 1305, the method may include transmitting, to a UE, a signal that identifies a RAR window configuration associated with a RACH procedure for the UE, where the RAR window configuration identifies a RAR window offset and an extended RAR window duration for a RAR window corresponding to a RACH occasion. In some examples, aspects of the operations of 1305 may be performed by a RAR window configuration manager 725.

At 1310, the method may include receiving, from the UE, a low-power uplink wakeup signal that identifies an uplink traffic pattern during an upcoming time window. In some examples, aspects of the operations of 1310 may be performed by a wakeup manager 750.

At 1315, the method may include receiving, from the UE and during the RACH occasion, a first RACH message to initiate the RACH procedure for the UE. In some examples, aspects of the operations of 1315 may be performed by a RACH message manager 730.

At 1320, the method may include transmitting, to the UE during the RAR window corresponding to the RACH occasion, a second RACH message associated with the first RACH message according to the RAR window configuration. In some examples, aspects of the operations of 1320 may be performed by a RACH message manager 730.

Implementation examples are described in the following numbered clauses:

Aspect 1: A method for wireless communications at a UE, including: receiving a signal that identifies a RAR window configuration associated with a RACH procedure for the UE, where the RAR window configuration identifies a RAR window offset and an extended RAR window duration for a RAR window corresponding to a RACH occasion; transmitting, during the RACH occasion, a first RACH message to initiate the RACH procedure for the UE; and monitoring, during the RAR window corresponding to the RACH occasion, for a second RACH message associated with the first RACH message according to the RAR window configuration.

Aspect 2: The method of aspect 1, where the RAR window offset includes a starting symbol offset, a starting slot offset, a SFN offset, or any combination thereof, between an end of the RACH occasion and the RAR window.

Aspect 3: The method of any of aspects 1 through 2, where the RAR window configuration is based on a NES operating mode of a network entity associated with the UE.

Aspect 4: The method of any of aspects 1 through 3, further including: receiving an activation signal that activates the RAR window configuration to be used for the RACH procedure for the UE from among a set of multiple RAR window configurations that include the RAR window configuration.

Aspect 5: The method of any of aspects 1 through 4, further including: receiving, after the RACH occasion and before the RAR window, a feedback notification that confirms receipt of the first RACH message, where the feedback notification is different from the second RACH message.

Aspect 6: The method of aspect 5, further including: receiving information that identifies a second RAR window for the UE to monitor for the feedback notification.

Aspect 7: The method of any of aspects 5 through 6, further including: transmitting, during a first RAR window that is before the RAR window, a second instance of the first RACH message on a second beam based on a beam change associated with the UE, where the first RACH message is transmitted on a first beam that is different from the second beam.

Aspect 8: The method of any of aspects 5 through 7, further including: applying a power ramping operation to a retransmission of the first RACH message based on an expiration of the RAR window, where the power ramping operation is based on a type of RAR window that has expired.

Aspect 9: The method of any of aspects 1 through 8, where the RAR window configuration includes a threshold RACH occasion density.

Aspect 10: The method of any of aspects 1 through 9, where the first RACH message includes a RACH message A and the second RACH message includes a RACH message B.

Aspect 11: The method of aspect 10, where the UE transmits a RACH message A preamble during the RACH occasion and transmits a RACH message A payload during an PUSCH occasion.

Aspect 12: The method of any of aspects 10 through 11, where the UE transmits a RACH message A preamble during the RACH occasion.

Aspect 13: The method of any of aspects 10 through 12, further including: receiving, after the RACH occasion and before the RAR window, a feedback notification that confirms receipt of the RACH message A.

Aspect 14: The method of any of aspects 1 through 13, where the first RACH message includes a request for an on-demand system information message, further including: receiving a feedback notification that acknowledges the request for the on-demand system information message.

Aspect 15: The method of any of aspects 1 through 14, further including: transmitting a low-power uplink wakeup signal that identifies an uplink traffic pattern during an upcoming time window.

Aspect 16: The method of any of aspects 1 through 15, where the first RACH message is transmitted to an assisting UE to be forwarded to a network entity.

Aspect 17: The method of any of aspects 1 through 16, further including: receiving the first RACH message from an assisted UE, where the UE includes an assisting UE associated with the assisted UE and transmitting the first RACH message includes forwarding the first RACH message from the assisted UE to a network entity.

Aspect 18: The method of aspect 17, where the first RACH message identifies a request for the network entity to transition to an active state.

Aspect 19: The method of any of aspects 1 through 18, where the first RACH message is transmitted via a SFN in conjunction with one or more other first RACH messages transmitted by a collaborating UE that is associated with the UE.

Aspect 20: A method for wireless communications at a network entity, including: transmitting, to a UE, a signal that identifies a RAR window configuration associated with a RACH procedure for the UE, where the RAR window configuration identifies a RAR window offset and an extended RAR window duration for a RAR window corresponding to a RACH occasion; receiving, from the UE and during the RACH occasion, a first RACH message to initiate the RACH procedure for the UE; and transmitting, to the UE during the RAR window corresponding to the RACH occasion, a second RACH message associated with the first RACH message according to the RAR window configuration.

Aspect 21: The method of aspect 20, where the RAR window offset includes a starting symbol offset, a starting slot offset, a SFN offset, or any combination thereof, between an end of the RACH occasion and the RAR window.

Aspect 22: The method of any of aspects 20 through 21, where the RAR window configuration is based on a NES operating mode of the network entity associated with the UE.

Aspect 23: The method of any of aspects 20 through 22, further including: transmitting, to the UE, an activation signal that activates the RAR window configuration to be used for the RACH procedure for the UE from among a set of multiple RAR window configurations that include the RAR window configuration.

Aspect 24: The method of any of aspects 20 through 23, further including: transmitting, to the UE after the RACH occasion and before the RAR window, a feedback notification that confirms receipt of the first RACH message, where the feedback notification is different from the second RACH message.

Aspect 25: The method of aspect 24, further including: transmitting, to the UE, information that identifies a second RAR window for the UE to monitor for the feedback notification.

Aspect 26: The method of any of aspects 24 through 25, further including: receiving, from the UE and during a first RAR window that is before the RAR window, a second instance of the first RACH message on a second beam based on a beam change associated with the UE, where the first RACH message is received on a first beam that is different from the second beam.

Aspect 27: The method of any of aspects 24 through 26, further including: transmitting, to the UE, a system information message that indicates a power ramping operation for the UE to apply to a retransmission of the first RACH message based on an expiration of the RAR window, where the power ramping operation is based on a type of RAR window that has expired.

Aspect 28: The method of any of aspects 20 through 27, where the RAR window configuration includes a threshold RACH occasion density.

Aspect 29: The method of any of aspects 20 through 28, where the first RACH message includes a RACH message A and the second RACH message includes a RACH message B.

Aspect 30: The method of aspect 29, where the network entity receives a RACH message A preamble during the RACH occasion and receives a RACH message A payload during an PUSCH occasion.

Aspect 31: The method of any of aspects 29 through 30, where the network entity receives a RACH message A preamble during the RACH occasion.

Aspect 32: The method of any of aspects 29 through 31, further including: transmitting, to the UE after the RACH occasion and before the RAR window, a feedback notification that confirms receipt of the RACH message A.

Aspect 33: The method of any of aspects 20 through 32, where the first RACH message includes a request for an on-demand system information message, further including: transmitting, to the UE, a feedback notification that acknowledges the request for the on-demand system information message.

Aspect 34: The method of any of aspects 20 through 33, further including: receiving, from the UE, a low-power uplink wakeup signal that identifies an uplink traffic pattern during an upcoming time window.

Aspect 35: The method of any of aspects 20 through 34, where the first RACH message is received from an assisting UE to be forwarded to the network entity for an assisted UE, the UE includes the assisting UE.

Aspect 36: The method of any of aspects 20 through 35, where the network entity receives the first RACH message from the UE.

Aspect 37: The method of aspect 36, where the first RACH message identifies a request for the network entity to transition to an active state.

Aspect 38: The method of any of aspects 20 through 37, where the first RACH message is received via a SFN in conjunction with one or more other first RACH messages transmitted by a collaborating UE that is associated with the UE.

Aspect 39: A UE, including: one or more memories storing processor-executable code; and one or more processors coupled with the one or more memories and individually or collectively operable to execute the code to cause the UE to: receive a signal that identifies a RAR window configuration associated with a RACH procedure for the UE, where the RAR window configuration identifies a RAR window offset and an extended RAR window duration for a RAR window corresponding to a RACH occasion; transmit, during the RACH occasion, a first RACH message to initiate the RACH procedure for the UE; and monitor, during the RAR window corresponding to the RACH occasion, for a second RACH message associated with the first RACH message according to the RAR window configuration.

Aspect 40: The UE of aspect 39, where the RAR window offset includes a starting symbol offset, a starting slot offset, a SFN offset, or any combination thereof, between an end of the RACH occasion and the RAR window.

Aspect 41: The UE of any of aspects 39 through 40, where the RAR window configuration is based on a NES operating mode of a network entity associated with the UE.

Aspect 42: The UE of any of aspects 39 through 41, where the one or more processors are individually or collectively further operable to execute the code to cause the UE to: receive an activation signal that activates the RAR window configuration to be used for the RACH procedure for the UE from among a set of multiple RAR window configurations that include the RAR window configuration.

Aspect 43: The UE of any of aspects 39 through 42, where the one or more processors are individually or collectively further operable to execute the code to cause the UE to: receive, after the RACH occasion and before the RAR window, a feedback notification that confirms receipt of the first RACH message, where the feedback notification is different from the second RACH message.

Aspect 44: The UE of aspect 43, where the one or more processors are individually or collectively further operable to execute the code to cause the UE to: receive information that identifies a second RAR window for the UE to monitor for the feedback notification.

Aspect 45: The UE of any of aspects 43 through 44, where the one or more processors are individually or collectively further operable to execute the code to cause the UE to: transmit, during a first RAR window that is before the RAR window, a second instance of the first RACH message on a second beam based on a beam change associated with the UE, where the first RACH message is transmitted on a first beam that is different from the second beam.

Aspect 46: The UE of any of aspects 43 through 45, where the one or more processors are individually or collectively further operable to execute the code to cause the UE to: apply a power ramping operation to a retransmission of the first RACH message based on an expiration of the RAR window, where the power ramping operation is based on a type of RAR window that has expired.

Aspect 47: The UE of any of aspects 39 through 46, where the RAR window configuration includes a threshold RACH occasion density.

Aspect 48: The UE of any of aspects 39 through 47, where the first RACH message includes a RACH message A and the second RACH message includes a RACH message B.

Aspect 49: The UE of aspect 48, where the UE transmits a RACH message A preamble during the RACH occasion and transmits a RACH message A payload during an PUSCH occasion.

Aspect 50: The UE of any of aspects 48 through 49, where the UE transmits a RACH message A preamble during the RACH occasion.

Aspect 51: The UE of any of aspects 48 through 50, where the one or more processors are individually or collectively further operable to execute the code to cause the UE to: receive, after the RACH occasion and before the RAR window, a feedback notification that confirms receipt of the RACH message A.

Aspect 52: The UE of any of aspects 39 through 51, where the first RACH message comprises a request for an on-demand system information message, the one or more processors are individually or collectively operable to execute the code to cause the UE to: receive a feedback notification that acknowledges the request for the on-demand system information message.

Aspect 53: The UE of any of aspects 39 through 52, where the one or more processors are individually or collectively further operable to execute the code to cause the UE to: transmit a low-power uplink wakeup signal that identifies an uplink traffic pattern during an upcoming time window.

Aspect 54: The UE of any of aspects 39 through 53, where the first RACH message is transmitted to an assisting UE to be forwarded to a network entity.

Aspect 55: The UE of any of aspects 39 through 54, where the one or more processors are individually or collectively further operable to execute the code to cause the UE to: receive the first RACH message from an assisted UE, where the UE includes an assisting UE associated with the assisted UE and transmitting the first RACH message includes forwarding the first RACH message from the assisted UE to a network entity.

Aspect 56: The UE of aspect 55, where the first RACH message identifies a request for the network entity to transition to an active state.

Aspect 57: The UE of any of aspects 39 through 56, where the first RACH message is transmitted via a SFN in conjunction with one or more other first RACH messages transmitted by a collaborating UE that is associated with the UE.

Aspect 58: A network entity, including: one or more memories storing processor-executable code; and one or more processors coupled with the one or more memories and individually or collectively operable to execute the code to cause the network entity to: transmit, to a UE, a signal that identifies a RAR window configuration associated with a RACH procedure for the UE, where the RAR window configuration identifies a RAR window offset and an extended RAR window duration for a RAR window corresponding to a RACH occasion; receive, from the UE and during the RACH occasion, a first RACH message to initiate the RACH procedure for the UE; and transmit, to the UE during the RAR window corresponding to the RACH occasion, a second RACH message associated with the first RACH message according to the RAR window configuration.

Aspect 59: The network entity of aspect 58, where the RAR window offset includes a starting symbol offset, a starting slot offset, a SFN offset, or any combination thereof, between an end of the RACH occasion and the RAR window.

Aspect 60: The network entity of any of aspects 58 through 59, where the RAR window configuration is based on a NES operating mode of the network entity associated with the UE.

Aspect 61: The network entity of any of aspects 58 through 60, where the one or more processors are individually or collectively further operable to execute the code to cause the network entity to: transmit, to the UE, an activation signal that activates the RAR window configuration to be used for the RACH procedure for the UE from among a set of multiple RAR window configurations that include the RAR window configuration.

Aspect 62: The network entity of any of aspects 58 through 61, where the one or more processors are individually or collectively further operable to execute the code to cause the network entity to: transmit, to the UE after the RACH occasion and before the RAR window, a feedback notification that confirms receipt of the first RACH message, where the feedback notification is different from the second RACH message.

Aspect 63: The network entity of aspect 62, where the one or more processors are individually or collectively further operable to execute the code to cause the network entity to: transmit, to the UE, information that identifies a second RAR window for the UE to monitor for the feedback notification.

Aspect 64: The network entity of any of aspects 62 through 63, where the one or more processors are individually or collectively further operable to execute the code to cause the network entity to: receive, from the UE and during a first RAR window that is before the RAR window, a second instance of the first RACH message on a second beam based on a beam change associated with the UE, where the first RACH message is received on a first beam that is different from the second beam.

Aspect 65: The network entity of any of aspects 62 through 64, where the one or more processors are individually or collectively further operable to execute the code to cause the network entity to: transmit, to the UE, a system information message that indicates a power ramping operation for the UE to apply to a retransmission of the first RACH message based on an expiration of the RAR window, where the power ramping operation is based on a type of RAR window that has expired.

Aspect 66: The network entity of any of aspects 58 through 65, where the RAR window configuration includes a threshold RACH occasion density.

Aspect 67: The network entity of any of aspects 58 through 66, where the first RACH message includes a RACH message A and the second RACH message includes a RACH message B.

Aspect 68: The network entity of aspect 67, where the network entity receives a RACH message A preamble during the RACH occasion and receives a RACH message A payload during an PUSCH occasion.

Aspect 69: The network entity of any of aspects 67 through 68, where the network entity receives a RACH message A preamble during the RACH occasion.

Aspect 70: The network entity of any of aspects 67 through 69, where the one or more processors are individually or collectively further operable to execute the code to cause the network entity to: transmit, to the UE after the RACH occasion and before the RAR window, a feedback notification that confirms receipt of the RACH message A.

Aspect 71: The network entity of any of aspects 58 through 70, where the first RACH message comprises a request for an on-demand system information message, the one or more processors are individually or collectively operable to execute the code to cause the network entity to: transmit, to the UE, a feedback notification that acknowledges the request for the on-demand system information message.

Aspect 72: The network entity of any of aspects 58 through 71, where the one or more processors are individually or collectively further operable to execute the code to cause the network entity to: receive, from the UE, a low-power uplink wakeup signal that identifies an uplink traffic pattern during an upcoming time window.

Aspect 73: The network entity of any of aspects 58 through 72, where the first RACH message is received from an assisting UE to be forwarded to the network entity for an assisted UE, the UE includes the assisting UE.

Aspect 74: The network entity of any of aspects 58 through 73, where the network entity receives the first RACH message from the UE.

Aspect 75: The network entity of aspect 74, where the first RACH message identifies a request for the network entity to transition to an active state.

Aspect 76: The network entity of any of aspects 58 through 75, where the first RACH message is received via a SFN in conjunction with one or more other first RACH messages transmitted by a collaborating UE that is associated with the UE.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code) stored in memory circuitry or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive a signal that identifies a random access response (RAR) window configuration associated with a random access channel (RACH) procedure for the UE, wherein the RAR window configuration identifies a RAR window offset and an extended RAR window duration for a RAR window corresponding to a RACH occasion;
transmit, during the RACH occasion, a first RACH message to initiate the RACH procedure for the UE; and
monitor, during the RAR window corresponding to the RACH occasion, for a second RACH message associated with the first RACH message according to the RAR window configuration.

2. The UE of claim 1, wherein the RAR window offset comprises a starting symbol offset, a starting slot offset, a system frame number (SFN) offset, or any combination thereof, between an end of the RACH occasion and the RAR window.

3. The UE of claim 1, wherein the RAR window configuration is based at least in part on a network energy saving (NES) operating mode of a network entity associated with the UE.

4. The UE of claim 1, wherein the processing system is further configured to cause the UE to:
receive an activation signal that activates the RAR window configuration to be used for the RACH procedure for the UE from among a plurality of RAR window configurations that include the RAR window configuration.

5. The UE of claim 1, wherein the processing system is further configured to cause the UE to:
receive, after the RACH occasion and before the RAR window, a feedback notification that confirms receipt of the first RACH message, wherein the feedback notification is different from the second RACH message.

6. The UE of claim 5, wherein the processing system is further configured to cause the UE to:
receive information that identifies a second RAR window for the UE to monitor for the feedback notification.

7. The UE of claim 5, wherein the processing system is further configured to cause the UE to:
transmit, during a first RAR window that is before the RAR window, a second instance of the first RACH message on a second beam based at least in part on a beam change associated with the UE, wherein the first RACH message is transmitted on a first beam that is different from the second beam.

8. The UE of claim 5, wherein the processing system is further configured to cause the UE to:
apply a power ramping operation to a retransmission of the first RACH message based at least in part on an expiration of the RAR window, wherein the power ramping operation is based at least in part on a type of RAR window that has expired.

9. The UE of claim 1, wherein the RAR window configuration comprises a threshold RACH occasion density.

10. The UE of claim 1, wherein the first RACH message comprises a RACH message A and the second RACH message comprises a RACH message B.

11. The UE of claim 10, wherein the UE transmits a RACH message A preamble during the RACH occasion and transmits a RACH message A payload during a physical uplink shared channel (PUSCH) occasion.

12. The UE of claim 10, wherein the UE transmits a RACH message A preamble during the RACH occasion.

13. The UE of claim 10, wherein the processing system is further configured to cause the UE to:
receive, after the RACH occasion and before the RAR window, a feedback notification that confirms receipt of the RACH message A.

14. The UE of claim 1, wherein the first RACH message comprises a request for an on-demand system information message, the processing system further configured to cause the UE to:
receive a feedback notification that acknowledges the request for the on-demand system information message.

15. The UE of claim 1, wherein the processing system is further configured to cause the UE to:
transmit a low-power uplink wakeup signal that identifies an uplink traffic pattern during an upcoming time window.

16. The UE of claim 1, wherein the first RACH message is transmitted to an assisting UE to be forwarded to a network entity.

17. The UE of claim 1, wherein the processing system is further configured to cause the UE to:
receive the first RACH message from an assisted UE, wherein the UE comprises an assisting UE associated with the assisted UE and transmitting the first RACH message comprises forwarding the first RACH message from the assisted UE to a network entity.

18. The UE of claim 17, wherein the first RACH message identifies a request for the network entity to transition to an active state.

19. The UE of claim 1, wherein the first RACH message is transmitted via a single frequency network (SFN) in conjunction with one or more other first RACH messages transmitted by a collaborating UE that is associated with the UE.

20. A network entity, comprising:
a processing system that includes processor circuitry and memory circuitry that stores code, the processing system configured to cause the network entity to:
transmit, to a user equipment (UE), a signal that identifies a random access response (RAR) window configuration associated with a random access channel (RACH) procedure for the UE, wherein the RAR window configuration identifies a RAR window offset and an extended RAR window duration for a RAR window corresponding to a RACH occasion;
receive, from the UE and during the RACH occasion, a first RACH message to initiate the RACH procedure for the UE; and
transmit, to the UE during the RAR window corresponding to the RACH occasion, a second RACH message associated with the first RACH message according to the RAR window configuration.

21. The network entity of claim 20, wherein the RAR window offset comprises a starting symbol offset, a starting slot offset, a system frame number (SFN) offset, or any combination thereof, between an end of the RACH occasion and the RAR window.

22. The network entity of claim 20, wherein the RAR window configuration is based at least in part on a network energy saving (NES) operating mode of the network entity associated with the UE.

23. The network entity of claim 20, wherein the processing system is further configured to cause the network entity to:
transmit, to the UE, an activation signal that activates the RAR window configuration to be used for the RACH procedure for the UE from among a plurality of RAR window configurations that include the RAR window configuration.

24. The network entity of claim 20, wherein the processing system is further configured to cause the network entity to:
transmit, to the UE after the RACH occasion and before the RAR window, a feedback notification that confirms receipt of the first RACH message, wherein the feedback notification is different from the second RACH message.

25. The network entity of claim 24, wherein the processing system is further configured to cause the network entity to:
transmit, to the UE, information that identifies a second RAR window for the UE to monitor for the feedback notification.

26. The network entity of claim 24, wherein the processing system is further configured to cause the network entity to:
receive, from the UE and during a first RAR window that is before the RAR window, a second instance of the first RACH message on a second beam based at least in part on a beam change associated with the UE, wherein the first RACH message is received on a first beam that is different from the second beam.

27. The network entity of claim 24, wherein the processing system is further configured to cause the network entity to:
transmit, to the UE, a system information message that indicates a power ramping operation for the UE to apply to a retransmission of the first RACH message based at least in part on an expiration of the RAR window, wherein the power ramping operation is based at least in part on a type of RAR window that has expired.

28. The network entity of claim 20, wherein the RAR window configuration comprises a threshold RACH occasion density.

29. The network entity of claim 20, wherein the first RACH message comprises a RACH message A and the second RACH message comprises a RACH message B.

30. A method for wireless communications at a user equipment (UE), comprising:
receiving a signal that identifies a random access response (RAR) window configuration associated with a random access channel (RACH) procedure for the UE, wherein the RAR window configuration identifies a RAR window offset and an extended RAR window duration for a RAR window corresponding to a RACH occasion;
transmitting, during the RACH occasion, a first RACH message to initiate the RACH procedure for the UE; and
monitoring, during the RAR window corresponding to the RACH occasion, for a second RACH message associated with the first RACH message according to the RAR window configuration.
